(19) United States
(12) Patent Application Publication
(10) Pub. No.: US 2002/0072993 A1
(43) Pub. Date: Jun. 13, 2002

(54) Method and system of an integrated business topography and virtual 3D network portal

(76) Inventors: James A. Sandus, Waukegan, IL (US); Frank C. Nicholas, Wilmette, IL (US)

Correspondence Address: CARDINAL LAW GROUP, Suite 2000, 1603 Orrington Avenue, Evanston, IL, 60201, US

(21) Appl. No.: 09/992,854

(22) Filed: Nov. 5, 2001

Related U.S. Application Data
(60) Provisional application No. 60/245,706, filed on Nov. 3, 2000.

(51) Int. Cl. G06F 17/60

(52) U.S. Cl. 705/26

(57) ABSTRACT

The invention provides a system and method of operating an on-line market system, including: receiving plurality of photo images of sides of a product from a seller, constructing a three dimensional product image from the photo images, and displaying the three dimensional product image in a three dimensional mall representation. The invention further provides further provides a system and method of operating an on-line market system, including: receiving at least one product image at a seller's node, storing the product information in a seller's database, constructing a three dimensional store, positioning the product image in the store, constructing a three dimensional mall, positioning the store in the mall, and providing buyer access to the mall from a buyer's node. The invention further provides further provides a system and method of operating an on-line market system, including: receiving buyer profile information from a buyer, storing the buyer profile information in a buyer's database, receiving ad selection input from an advertiser, receiving a purchase input from the buyer, and displaying an ad from the ad selection input in a three dimensional mall based on the buyer profile in response to the received purchase input. The invention further provides further provides a system and method of operating an on-line market system, including: receiving product data from a plurality of sellers, storing the product data in a database, receiving product category search criteria, and constructing a store to include product data based on the product data matching the product category search criteria. The invention further provides further provides a system and method of operating an on-line market system, including: receiving user character selection input from a buyer, constructing a three dimensional shopper based on the character selection input, directing the three dimensional shopper through a three dimensional mall, and interacting the shopper with three dimensional solicitors. The invention further provides further provides a system and method of operating an on-line market system, including: receiving buyer friend input from a buyer, linking a three dimensional friend corresponding to the buyer friend input via a network connection with a three dimensional buyer in a three dimensional mall, and sending an identical visual display to operators of both the three dimensional fiend and the three dimensional buyer via a network during the linkage. The invention further provides further provides a system and method of operating an on-line market system, including opening at least one connection between a mall network and a first buyer, opening at least one secured connection between a mall network and a second buyer, and routing communications between the first buyer and the second buyer a network connection between the buyer and second buyer via the secured connections. The invention further provides further provides a system and method of operating an on-line market system, including: receiving buyer purchase input, comparing the buyer purchase input to a database of product categories with corresponding ads, and transmitting an ad corresponding to the product category matching the purchase input to a billboard space in the on-line mall.

### FIELD OF THE INVENTION

In general, the invention relates to digital communications. More specifically, the invention relates to e-commerce and Internet asynchronous communications and particularly, to the simulation of brick and mortar businesses.

### BACKGROUND OF THE INVENTION

The fast pace of modern capitalism has nurtured a mass or new technologies. A new market to emerge from these technologies is e-commerce, with the participating commercial entities providing the content e-business. E-commerce has arguably brought about the most significant changes in the purchasing habits of consumers since the advent of the department store 100 years ago, changing the very business structure of global markets. E-business as well, has brought about significant changes to business-to-business transactions, redefining many of the most time proven of business models. The introduction of the Internet into businesses and homes has made for the first time, a truly world wide market.

In the short history of e-commerce on the Internet, yearly transactions have exceeded into hundreds of billions of dollars. Further, the yearly transactions are expected to reach and surpass 1 trillion dollars. This sudden financial success of the Internet has inspired the creation of entire industries, they of which are made up of thousands of startup companies accompanied by traditional corporations entering into the Internet world. In order to function in the world of e-commerce, companies providing e-business have created and implemented even more technology, as well as define entirely new business topologies. Even with all of the planning that has been implemented by this corporate insurgence however, consumer and business related problems have developed and have become more apparent as the business models are time tested.

Customer dissatisfaction is possibly the worst of the problems to arise. Whether the customer is a consumer or business, commercial e-business success requires they remain satisfied. One potential cause of e-commerce businesses losing sales is hosting a cumbersome and annoyingly complex Web site. Requiring customers to navigate through extensive forms and linked pages, defeats the most sophisticated of Web site designs. Many customers simply give up mid-transaction and take their business to another site with less bureaucratic overhead, or they take their needs to a traditional brick and mortar business. There's no use spending time at a web site if you can't find what you're looking for. Avoiding this type of customer annoyance requires technical and business solutions that retain customers from registration throughout the payment process. The term “customer annoyances” can best be defined as an obstacle presented prior to registering, browsing, selecting, or purchasing products on-line.

For consumer or business customers alike, annoyances can include complicated registration requirements, inconsistent purchase experiences across sites, establishing and maintaining numerous “identities” (passwords and preferences) for sites hosting multiple businesses, and requiring different payment methods at different Web sites. Additionally, annoyance can be associated with fear of supplying personal or corporate information, fear of absent chat room or transaction security, and fear of being swindled by a misrepresented transaction. A problem from the business standpoint is that customer annoyance must be accepted to a certain degree in order to repel acts of fraud. Buying hard or digital goods on the Web will always require a certain level of information from consumers.

The issue of security, though decreasing is still a large annoyance for both business and consumer customers alike. Every e-commerce transaction implies the passage of information about the seller's products and pricing, and the buyer's financial details and shopping preferences. Businesses storing this information can use it to boost revenues and lower costs, but the very act of data transmission opens up networks and servers to external and, more significantly, internal attacks. Customers providing information receive in return improved customer care, as companies learn the customers tastes, needs, and buying patterns. However, the customer annoyance is attributed when the business receiving the information sells it to other vendors without concern for its use and most often without the customers knowledge.

Because of its distribution and presentation flexibility, e-commerce appeals to many different kinds of business models. Different business models have also affected the level of customer annoyance on a Web site. For the business-to-consumer model, retail sales of individual products contribute the largest percentage to the total Web sites revenue. The business to consumer model can sell products as hard goods, or digital goods. Each type of goods sold has specific inherent annoyances. To understand the annoyance source, hard goods and digital goods need to be described.

Hard goods vendors use the Internet as a marketing and order-processing center, while the product is distributed through a traditional order fulfillment process. These hard goods vendors increase profit margins by decreasing the cost of marketing, by taking orders from a broader customer base, and by supplementing operational costs with the sale of statistical information. Hard goods were the first kind of product in the e-commerce arena. Companies selling everything from flowers, to books, to CDs wanted to find a more efficient and scalable channel than traditional brick and mortar stores. The vendor takes customer information and payment methods through the Internet, and starts the purchase down the established assembly line of order fulfillment.

Digital goods are products whose content is sold and delivered over the Internet. These goods are becoming increasingly popular in the Internet marketplace. Software, streaming video, access to games, daily newspapers, analysts' reports, database searches, information services images, graphics, subscriptions, and even product support are all part of this newer market. The profit margin for digital content are quite high since the vendor pays for only the initial product production and spends no money to manufacture and deliver each product sold. This is very different from hard goods where each sale implies manufacturing and distribution costs. In addition, no inventory monitoring is required for digital goods since selling the product does not diminish supply. Further, the vendor collects payment on purchase, cutting down on fraud and false remittance. Most importantly to the consumer, digital goods provide customers with immediate access to the product they purchase.

Both of these methods for a business-to-consumer model of e-business can be very profitable however, because of the cost of product manufacturing and distribution, and because of the additional information required for shipping, e-commerce sites selling hard goods must be additionally sympathetic to customer annoyance. The customer annoyance of digital goods however, is that customers usually cannot return data for a refund once purchased. Additionally, it is often difficult or impossible to move downloaded software from one computer to another. In addition, the number of customers will be less then those seeking hard goods because of the inherent consumer attitude that purchased goods must be in a physical form.

Additional to the problems of customer annoyance's the business-to-consumer topography is also presented with the classic challenge of how to draw the customer into the store, offer an engaging product, and persuade the customer to go through with the purchase. The marketing of a Web site and its products present the need to provide a different (Internet) form of “pitching” a product. Due to the young age of e-businesses, there is not a lot of reliable background marketing data available to produce preferred marketing schemes with any assurance of success. It is arguable though, that more difficult is actually getting a customer to go through with the purchase. Unlike business-to-business sites, business-to-consumer sites have to worry about perceived rather than known customers. The business-to-consumer e-business does not know much about a customer entering the store beyond the fact that they have access to the Internet. The business-to-consumer e-business does not know how familiar the customer is with buying products on-line, their tastes, or even if their credit card is good. As a result, the business-to-consumer e-business is often working in the dark when determining exactly how many registration, customer information, or purchase screens the customer will put up with before leaving the site.

Even if an e-business ignores the customer fear of disclosing personal or credit card information over the Internet, the frustration with completing endless HTML forms remains. An e-business trying to gather information about a customer may inadvertently require a customer to fill out six or more forms including registration, address information, a demographic survey, order information, payment information, and shipping information. With that many fields to fill out, the consumer may leave the store without finishing the purchase process.

Another type of business topography is the business-to-business model. For business-to-business Web sites, the customer is the employee who uses the site to perform some portion of his or her business workflow. Despite the complexities of building a business-to-business site, it can often be easier then business-to-consumer sites because the host business knows their audience. The host business gets to specify the required browser, ODBC driver, or other environmental variables as the site developer. In addition, the host business can assume that the employee (or at least someone in the management chain) using the site has some training.

For a business-to-business site, a key problem is successfully integrating with the customers business system. Merging the two business workflows, without disrupting processes like invoicing, auditing, and bill remittance ranks as a top priority. The complexity of a business-to-business site increases with the level of integration between the two business workflows. An additional problem for a business-to-business site is caused by site developers. Typically, developers tend to focus on ease-of-use issues rather than the business customers concern for reduced annoyance. Ease of use for business-to-business sites is measured by the learning curve for training on the site and the facility of interactivity deployment. Although the facility of deployment is of importance to both business partners, the ease of site use does not represent a streamlined process for the user, who is more concerned with minimizing customer annoyance.

Regardless of the topography, customer annoyance generated by requiring customer information for registration and payment is caused by the stateless nature of HTTP. Since data cannot be manipulated in HTTP, in order to maintain state on a Web site the e-business must provide alternate ways to store the customer data that the e-business needs to populate server-side databases and drive page navigation. Two technologies available for maintaining information on the customer for Internet commerce are electronic wallets and cookies. These technologies can also cause customer annoyance.

Electronic wallet technology was first introduced in 1996. To date, electronic wallets have not gained widespread acceptance. A client wallet, in which the customer stores address and payment information, provides several advantages. By offering a familiar and easy-to-use graphical interface, wallets ad a friendly and familiar atmosphere to the purchase process. When the customer visits a Web site that supports the wallet, the customer can register at the sites and pay for products by simply opening the wallet and clicking the preferred address or credit card. The customer does not have to fill out any forms. The wallet handles the transfer of the information from the customer to the server, usually over HTTP with Secure Sockets Layer (SSL). Another advantage is Wallets are generally a free download.

The disadvantage to wallets is first, using a wallet requires a customer to download or install the product that includes the wallet software. A download/install requirement causes customer annoyance by adding an extra step to the purchase process and extra files to a client's hard drive. Downloading the wallet could also require extensive (and expensive) customer support if the wallet doesn't integrate smoothly with the user environment. Customers are also restricted to purchasing from the computer storing the wallet. On the server side, the e-commerce site must support the wallet for a customer to take advantage of it. A good number of sites already support the main wallet implementations, however the dependencies on server support and customer downloads reduce the benefits of the wallet to a specific subset of consumers. Since wallets are not supported across all Web sites, customers don't know if they can use their wallet at a site until they reach the point of purchase. Even if the e-business host integrates support for multiple wallets onto their commerce site, they still need to find a way to reduce customer annoyance for non-wallet carrying customers.

The wallets counterpart are cookies. Opinions vary widely about the safety and intrusiveness of cookies, but it cannot be argued of their convenience. Cookies are simply text files containing customer-variable information that reside on the customers hard drive. Cookie data contains information gathered while the customer navigates through the Web sites. Data ranges from a history of the pages a customer has visited, to personal information entered once in HTML forms. Cookies do not contain any information that has not already been provided by the customer in a form or navigation path. Each Web site generates its own cookies. If an airline provides a cookie during a ticket purchase, an on-line music store cannot access that cookie and read that cookie's data when the customer visits the new site. E-businesses can write cookies to a customers hard drive using DHTML or through Active Server Pages.

The main drawback to implementing cookie technology by an e-business is the negative image that has fostered due to the cookies being downloaded to the customers hard drive. Additionally, the cookies usually remain in the clients folder regardless of time, thus adding unwanted clutter to already confusing folders.

An additional source of problems for e-commerce topologies is their marketing techniques. One source of site marketing is known as banners. Banners can do quite a bit for building brand-name recognition of a company, a website, and a product or service. This is achieved by producing a banner that will be repetitively run on a Web site. If a customer finds the information of the banner useful, the customer can double click on the banner and the HTTP e-business address attached to the banner ad is executed to their browser. Additional customer exposure can be achieved by placing the banner on a banner exchange.

Banner exchanges allow companies with non-extending operating budgets to compete with multi-million dollar corporations by placing the banner ad on a virtual billboard. The banner ad rotates with other ads with a rate of recurrence dependent on the subscription price paid. In addition, the exchange conditions require each participating e-business host a billboard in order that other exchange customer banner ads can be shown on each participating e-business site.

Despite the marketing potential of banner ads, the problems with their use are numerous. First, a resent marketing research report states that banner advertising rates fairly low when compared to the less popular but much more effective e-mail to customers marketing method. Next, banner exchanges are becoming so crowded that many exchanges are rotating the banners at a rate making one e-business banner unlikely to be viewed by each visiting customer. Additionally, typical click-through ratios run between 0.5 and 1.5 percent. Banners can also be distracting and often ugly with banner exchanges having no way of guaranteeing that the banner in rotation at any given moment won't clash horribly with an e-businesses site graphics. In addition, banners increase the load time of Web pages.

Beside banner ads, additional marketing problems can be associated with an e-businesses Web site design. With shopping on the Internet now commonplace, most of the major retailers have their own Web site. Typically, these mass merchant Web sites restrict the sale of merchandise to their brands only. The problem with limited brands is that if a customer wishes to purchase a product not in the mass merchants product listing, the customer must access another site, or access a different e-business search engine to find the desired product. Another type of Web site offers a search for products, using search routines to find the product in multiple e-business locations, giving the customer a choice of vendors. Again, the customer is forced to access another site in order to purchase the product. Both of these e-businesses have a further problem because they search for products by a product category or by the exact product name. This type of search must assume that the consumer knows what he or she is looking for, and often the exact name and model.

Another marketing problem associated with e-business Web site design is that the latest product designs are often attributed to the Web sites product renditions months after the revised products have been on the shelves of the brick and mortar stores. This delay of revising products can cause further problems if the product is discontinued, or out of inventory due to production delays or other reasons.

Additionally, e-business Web sites are typically designed to be efficient and functional but not aesthetically pleasing to customers with various preferences. The problem of lost customers is then created if consumers with various tastes, religious afflictions, national heritage, or social status desire to shop at a site of more comfortable and familiar surroundings. In addition, customers of different groups or tastes may not be offered the proper products through search routines due to misinterpretations of the searched product group.

Therefore, it would be desirable to alter the techniques currently used for e-commerce Web site design in order to restrict or eliminate the causes of customer annoyance. Additionally, it is desirable to create a Web site design capable of supporting multiple vendors. It would also be desirable for a Web site design to be capable of quickly altering and updating product information for the multiple vendors. Further, it would be desirable for the Web site design to be compatible under the use of a wide variety of customer types. Additionally, it would be desirable for a Web site design to implement useful and technologically advanced features required by business customers, while remaining compatible with the consumer customers capabilities.

It would be desirable to create a business topography capable of providing for both business and consumer customers. It would be desirable for a business topography to provide enhanced customer service features while using less intrusive data marketing techniques. Further, it would be desirable that the business topography design a means for providing customers with a common identity and purchasing process usable for multiple e-businesses. It would be desirable for a business topography to also implement non-intrusive program and security techniques while maintaining a history of the client's purchases for a customized shopping experience. Further, it would be desirable that a business topography introduce marketing techniques suitable for sustaining a visually pleasing shopping experience while still providing product and service awareness to the customers. In addition, it would be desirable that a business topography be capable of supporting business-to-customer and business-to-business e-commerce.

Thus, there is a significant need for a method and system for networked transactions that overcome the above disadvantages and shortcomings, as well as other disadvantages.

### BRIEF DESCRIPTION OF THE DRAWINGS

FIG. 1 is a flow diagram of a market system communications network;

FIG. 2A is an illustration of a network of predefined grids called the graphic consumer interface (GCI) in communication with the market system;

FIG. 2 is an illustration of a modular mall and its internal parts constructed using the graphic consumer interface grids;

FIG. 3 is an illustration of a modular store interior with a display case, imbedded within the modular mall;

FIG. 4 is an illustration of a seller registration page for the market system communications network;

FIG. 5 is an illustration of a product information page in communication with the market system;

FIG. 6 is an illustration of a floor and product layout preference page in communication with the market system;

FIG. 7 is an illustration of an apparel viewing area imbedded within the modular mall;

FIG. 7A is an illustration of imbedded components of an apparel viewing area imbedded within the modular mall;

FIG. 8 is an illustration of custom mall shopping characters imbedded within the modular mall;

FIG. 8A is an illustration of custom mall shopping characters facial and speech characteristics imbedded within the modular mall;

FIG. 8B is an illustration of a waveform phoneme comparison table used for custom mall shopping characters facial and speech characteristics;

FIG. 9 is a flow diagram of an alternate market system communications network; network;

FIG. 10 is an illustration of a storefront placement acceptance module, in communication with the market system;

FIG. 11 is an illustration of an advertisers registration page in communication with the market system;

FIG. 12 is an illustration of product category module in communication with the market system;

FIG. 13 is an illustration of product subclass module in communication with the market system;

FIG. 14 is an illustration of a product manufacturer identification page in communication with the market system;

FIG. 15 is a sales diagram of a product category as supplied by the market system;

FIG. 16 is an illustration of a product hit information page in communication with the market system;

FIG. 17 is an illustration of a demographic data page in communication with the market system;

FIG. 18 is an illustration of a advertiser mall selection page in communication with the market system;

FIG. 19 is an illustration of a product category selection page in communication with the market system;

FIG. 20 is an illustration of a manufacturer selection page in communication with the market system;

FIG. 21 is an illustration of a advertiser bid page in communication with the market system;

FIG. 22 is an illustration of advertisement layout page in communication with the market system;

FIG. 23 is an illustration of a direct product bid page in communication with the market system;

FIG. 24 is an illustration of advertisers solicitors imbedded within the modular mall;

FIG. 25 is an illustration of an advertiser billboard request in communication with the market system;

FIG. 26 is an illustration of a buyer registration page in communication with the market system;

FIG. 27 is an illustration of a character selection page in communication with the market system;

FIG. 28 is an illustration of a character approval page in communication with the market system;

FIG. 29 is an illustration of a character wardrobe selection page in communication with the market system;

FIG. 30 is an illustration of a customer mall preference page in communication with the market system;

FIG. 31 is an illustration of a custom mall top view in communication with the market system;

FIG. 32 is an illustration of a custom mall side view in communication with the market system;

FIG. 33 is an illustration of a store top view in communication with the market system;

FIG. 34 is an illustration of an enhanced product view imbedded within the modular mall;

FIG. 35 is an illustration of a dynamic advertiser in communication with the market system;

FIG. 36 is an illustration of a buyer pedway or search engine in communication with the market system;

FIG. 37 is an illustration of custom mall group shopping characters imbedded within the modular mall; and

FIG. 38 is an illustration of a price checking service in communication with the market system.

### DETAILED DESCRIPTION OF A PREFERRED EMBODIMENT

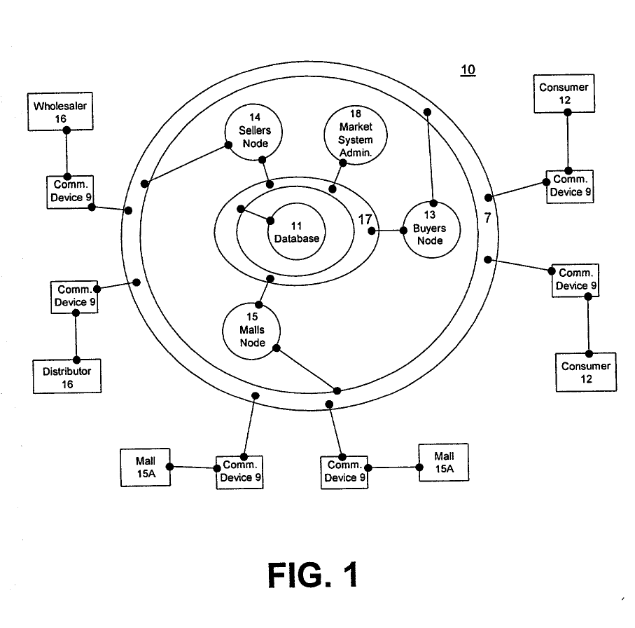

Referring to FIG. 1, one embodiment of a market system is generally shown at numeral 10. Market system 10 may include a communication node (buyer node 13, seller node 14, and mall node 15), which may be accessed by a communications device 9 through wire or wireless networks or systems (i.e., telephone or televisions systems, integrated services digital network (ISDN) systems, coaxial lines, computer networks, digital end user lines, private networks, wireless local loop systems, etc.). The communication network 7 of the market system 10 can be a type including, but not limited to intranets, extranets, a local area network, a wide area network, a telephone network, (e.g., a public switched telephone network (PSTN), private telephone networks, etc.), a cellular network, satellite networks, a personal communication system, a TV network (e.g., a cable TV system), local, regional, national or global paging networks, an e-mail system, a wireless data network (e.g., satellite data or local wireless data networks), a wireless LAN, a wireless local loop/distribution system (e.g., LMDS, MMDS or Code Division Multiple Access (CDMA) based system), a Voice Over Internet Protocol (VOIP) network, or any other similar on-line service. It will be recognized that the communication network may have portions in common, may comprise two separate networks, or may be the same network.

In one embodiment, accessing a database 11 requires a communication device 9 to connect to a local network (LAN) 17. The communication device 9 of a wholesaler or distributor (seller) 16, a mall 15A or a consumer (buyer) 12 can attempt to make a network connection to a communication node 13, 14, or 15 by creating a socket from the seller 16, mall 15A, or buyer 12 to a communication node 13, 14, or 15. For one embodiment of the invention, when a socket is connected to a communication node 13, 14, or 15, the communication device 9 may remain in an active loop with communication node 13, 14, or 15, until terminated by the seller 16, mall 15A, or buyer 12. In a like fashion, communication node 13,14, or 15 may requests a socket connection with a database 11, thus providing the initial requested connectivity. Another embodiment may establish node of one or more socket connections to one or more communication node 13, 14, or 15, to be maintained simultaneously and may have, but is not limited to socket types of stream socket, datagram socket, and raw socket or any combination thereof. Dependent on the level and function of the market system 10 when a seller 16, mall 15A, or buyer 12 access' a communication node 13, 14, or 15, the seller 16, mall 15A, or buyer 12 can determine the socket type required for the desired performance.

The communication nodes 13, 14, 15 of the market system 10 can include, but are not limited to an interactive voice response node, a server computer, an interactive HTML (Web) page, and/or other suitable interactive applications. It will be recognized that the communication nodes 13, 14, 15 may be integrated within or may be remote from the communication networks 7, and/or the LAN 17.

The communication nodes 13,14,15 may be in communication with a database 11 via the LAN 17 in a like manner as described above. The database 11 can be of one database performing operations on all required stored data, however an alternative embodiment may have multiple databases, each operating in communication with each other and the LAN 17. Another embodiment may have multiple databases 11 with no interconnectivity to each other, but all in communication with the LAN 17. A market system administration 18 can be responsible for part or all of market system 10 operations including but not limited to design, business operations, and database control, and may be in communication with the database 11 and communications nodes 13, 14, 15 via the LAN 17 in a like manner as described above. The buyer's node 13 network connection may be accessed by the communication device 9 of a potential buyer 12 also known as customer and consumer, and may be comprised of any individual, private citizens, and business personnel. In one embodiment shown in FIG. 1, the buyer's node 13 can communicate with a seller's node 14. In another embodiment of the invention, the communication between the buyer's node 13 and seller's node 14 is managed by a database 11 wherein the buyer's node 13 and seller's node 14 may have separate connections to the database 11. The embodiment of FIG. 1 can provide communication management through the LAN 17, but alternative methods can be used. In the manner previously described for linking the buyer node 13 and a potential buyer 12, the seller node 14 may be accessed by a seller (e-business and vender) 16, and may be comprised of retailers, wholesalers, and manufacturers. Another embodiment can provide communication between one or more buyer node 13, seller node 14, and/or mall node 15, and may be managed by a database 11, the mall 15A, or alternative method.

In one embodiment of the invention, the seller's node 14 can make available to a potential seller 16 an interface that provides seller services as offered by the market system administration 18. Example services include but are not limited to, allowing a potential seller 16 to register as a valid new or returning seller 16, with the market system administration 18 providing seller specific graphic functions and incorporating and selecting seller 16 products to be displayed in one or more malls 15, 15A. The malls may be accessed by buyers 12 via the buyer's node 13 and the mall node 15 in the same manner as the before mentioned communication between the sellers node 14 and the buyers node 13.

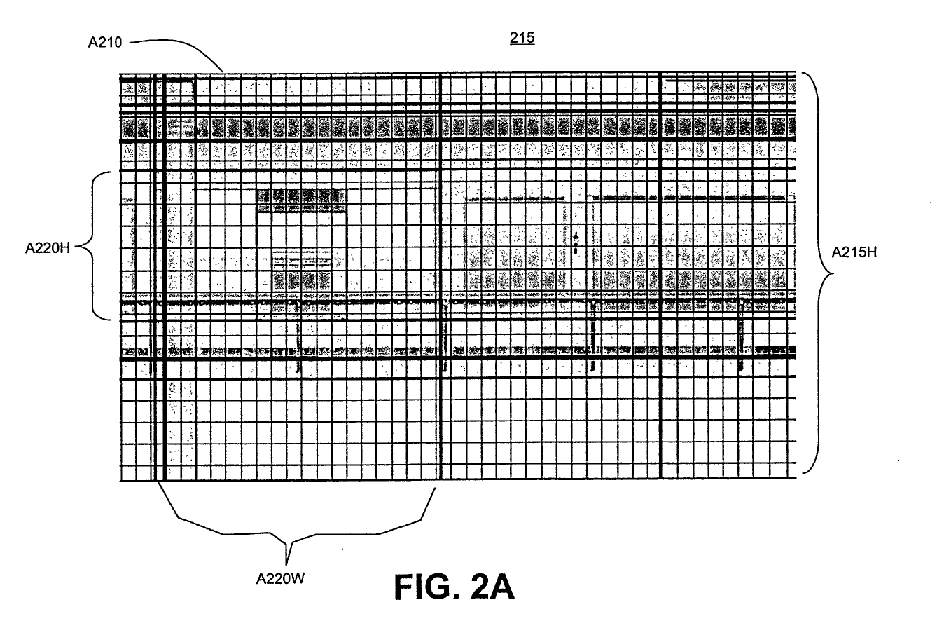

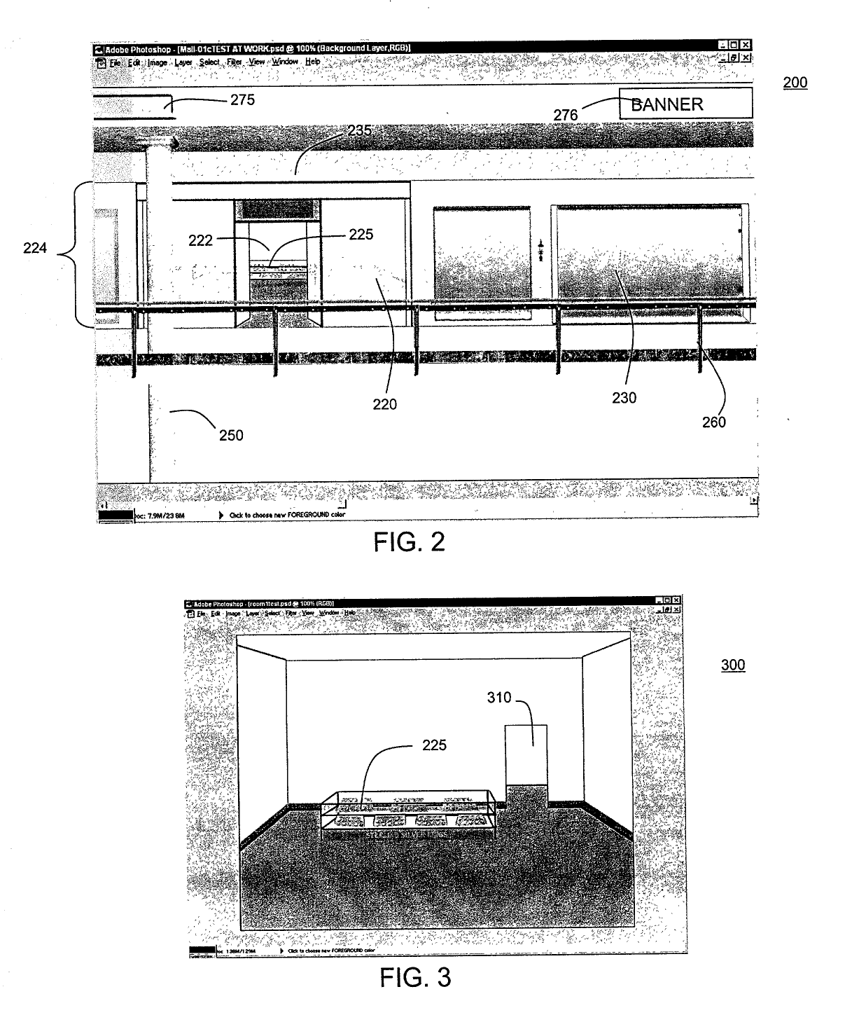

Illustrated in FIG. 2A, one embodiment of a mall can be constructed, illustrated, and/or animated using a modular composition algorithm named a graphic consumer interface (GCI) 215. The purpose of the GCI 215 is to offer the customer a means to view items for sale and to do business with merchants, in an environment reproduced as a typical and customary brick and mortar institution.

The GCI 215 may include connectivity and functionality with one or more database, program, network, communication node, communication device, and/or protocol. For another embodiment of the invention, the GCI 215 may incorporate or be configured for accepting structured inputs, processing the inputs in accordance with prescribed rules, and outputting specific mall attributes including specific stores as defined by the processing results of mapped Internet Protocol addresses to geographical location information as would occur to those having ordinary skill in the art, such as, for example, a server commercially available by Quova, Inc. Additionally, the GCI 215 may include a network of predefined grids A210, each with its own identifier and assigned pixel location. The grids A210 may be composed of cells, and for one embodiment of the invention, each cell may be appointed attributes for use by a market system database. In another embodiment of the invention the attributes can include all or part of cell numbers, grid numbers, current pixel locations, assigned locations, and scale ratio numbers. Alternative embodiments of the attributes may have different lists of information. An alternative embodiment of the GCI 215 can incorporate programmed functions to allow the GCI 215 to construct a mall and all internal parts including but not limited to stores, products, and displays from construction information provided by attributes, a buyer, a database, or a combination thereof. A function of the constructed mall may include it to be viewed by the buyer on the buyer's output device attached to the communications device. An alternative embodiment may allow interactive virtual reality (IVR) to be implemented within the market system, which can provide the mall with interactions and scenarios through the GCI 215 or alternative GUI. Additionally, the GCI 215 may incorporate or act as an Internet browser or browser plug-in. IVR includes support for various input devices used in virtual reality applications for example; gloves can be used to manipulate the products on a shelf. The invention can provide IVR technology known in the art and as described by Prosolvia Clarus Co. of Sweden at http://www.vrs.org.uk/VR/soft/clarus/clarus.html#crtl to be implemented for all or part of the market system.

As illustrated in FIG. 2A, an embodiment of the invention may provide the grids A210 to be overlaid upon each other in a fashion allowing for a minimum overlap. Additionally, grids A210 may include a Z-axis as well as the typical X and Y-axis and may interact as a typical mathematical array. In another embodiment of the invention, any combination of one or more axis may also overlap itself or each other. This overlapping can be used to hide any errors caused by html translation in browsers. An example for locating a grid for storefront insertion within a mall may be illustrated as the sections A220H, and A220W. In yet another embodiment of the invention, the grids A210 may use polar coordinates, radial coordinates and/or Cartesian coordinates. An example of the GCI 215 embodiments where coordinates detail the grid location of a mall and associated parts is illustrated in FIG. 2.

In one embodiment of the invention referring to FIG. 2, a mall of malls 200 and its internal parts may appear to the viewer as three-dimensional but it may include two-dimensional attributes. In another embodiment of the invention the mall 200 data may include three-dimensional attributes. In a further embodiment, the mall 200 may include both two and three-dimensional attributes in combination, and may be used for enhance viewing, texture wrapping, finite element analysis, scaling, or bit sizing of an image or element of the mall 200. Additionally, embodiments may construct the mall 200 and its internal parts as two-dimension graphics using techniques known in the art, as true three-dimensional graphics utilizing the Z-axis using techniques known in the art, or as any combination of three-dimensional graphics and two-dimensional graphics. Two-dimensional graphic construction can include but is not limited to bitmap graphics, textures, and lightmaps. Three-dimensional graphic construction can include but is not limited to vector graphics, polygon graphics, real-time 3D rendering, and “low polygon character” construction using real-time 3D rendering technology. In addition, the three-dimensional graphic construction of the mall 200 and all or part of its components may include IVR technology. Programming of the mall 200 may be done using program languages, platforms and techniques known to the art. In one embodiment, the three-dimensional appearance of the mall 200 may be simulated using various techniques including, utilizing vector graphics, layering two-dimensional images, creating perspective images, or the like. As illustrated in FIG. 2, a plurality of store faces 220, 230 may be simulated with a three dimensional appearance, and may include additional visual attributes such as a sellers product display 225.

An alternative embodiment of the invention may create a three-dimensional appearance of the mall 200 and its contents utilizing interactive photography as is known in the art. Interactive photography can allow the showing of objects via multiple view angles rotated in every direction by simple mouse manipulation. Seen from a distance, it can give objects a 3-dimension appearance.

Prior to the construction of the mall 200, the storefronts 220, 230 may be constructed to include portions transparent to the layers under them, giving the affect of a store window. Each storefront can be assigned an ID number for storing all associated attributes and/or files in the market system database. In another embodiment, when the market system database receives a query for a specified storefront ID, the storefront 220 may be retrieved from a library file and passed to the grid location 235 that places the storefront directly over a store background 222. The construction begins for one embodiment of the invention, with the retrieval of a mall concept page placed in a grid location to act as a background. In one embodiment, multiple concept pages can be created and stored in a library and cataloged for retrieval when queried. Each concept page may be created with a different motif to transform the mall 200. For example, an exotic, elegant, historic, or extraterrestrial mall 200 or the like may be visually created from predefined motifs. In one embodiment, the motif of a concept page may be assigned as an attribute to the concept page, and to the other entities of the malls construction that are recognized as having the same motif as the concept page. In one embodiment, the additional mall entities include but are not limited to windows 275, advertisement billboards 276, pillars 250, handrails 260, store faces 220, 230 and store displays 225. In another embodiment, the motifs can be accessed by the buyer and can be made a preference for each visit to the mall 200. Therefore, mall 200 graphic variations may include, for example, a baby products mall, teen mall, Baby Boomer mall, outdoorsman mall, sportsman mall, gender malls, ethnic malls, product category malls, a space station mall, an underwater mall, planet malls, alien malls, African savanna mall, etc.

The market system may accommodate any number of malls 200, which may be accessed by buyers via the buyer's node. Unlike the motifs, which have the same internal store names and products, another embodiment may provide themes, which can have entire new store names and products. In one embodiment, the background 222 and related theme setting components may be further graphically enhanced based on, for example, product type, geographic location, language, pricing, etc. An example of a theme setting can be for a buyer to select a discount store theme, and only discount stores would populate the viewable mall regardless of motif. In one embodiment, the buyer's node may have any number of malls in communication with it. The buyers may then access any of the mall 200 based on their preference. In one embodiment, the theme malls can be provided to the buyer node and seller node as components listed in the database. The preferred theme can be first chosen from a list of themes located in a settings pull down menu on a mall 200 splash page however, alternative methods and locations may be used. Once a theme is selected, a function can be activated that copies the theme choice identifier to a variable. The GCI program 215 may activate and read a list of variables, which can include the theme identifier. The GCI program 215 can use the theme identifier, as well as other user defined and preset variables, to access the database 11 and query for the proper components needed to fulfill the requested theme. In one embodiment, a query may not be needed since the choice identifier is part of a string that identifies the needed theme parts by database location and ID.

All parts to the mall 200 can be constructed, stored, and retrieved using the modular application of GCI 215. By using the appropriate grid number and part id, the mall attributes of windows 275, pillars 250, handrails 260, and store arrangement 224 can provide numerous variations of custom appearances, or they can be placed in a default state for first time retrieval. The modular approach may also allow for the mall 200 to continue from one page to the next, allowing the mall 200 to be of any length that is needed. Visual enhancements such as fountains, escalators, and mall shows may be used where appropriate to make a realistic mall conception. An example of the browsing process from one embodiment of a mall 200 places a customer service desk and/or a mall map visible on the first graphic rendition (home html page). In one embodiment of the invention, the customer service desk or mall map may activate a search or help feature by moving a cursor over the image of the customer service desk or mall map and double clicking the mouse, thus activating the search or help feature. In one embodiment, double clicking, rollover, and right clicking on and over site items can activate features such as but not limited to search engines, product information, or on line help. Additional activation techniques known in the art may also be used. These features may be built using C++, Java, or similar programming codes known in the art. Additionally, the consumer may choose to move freely throughout all parts of the mall 200 to browse for items of interest. Frames as are known in the art may be used to allow quick access to additional features such as a search feature, shopping cart, and mall map. A frame can accompany all Web pages but in one embodiment may, be discrete as possible in order to avoid disturbing the overall shopping experiences. Storefronts 220, 230 may be of varying sizes but in one embodiment, must maintain the modular specifications as directed by the market system administration. By double clicking on an intended storefront 220 or 230, using the search engine to locate a specific store, or accepting a store suggested for a specific product search, one embodiment of the invention can provide a buyer to view the mall rebuilt to contain the requested or accepted graphical information (store, item, etc). An example of this is illustrated in FIG. 3, which may be the result of accessing (in one embodiment double clicking) the storefront 220.

Referring to FIG. 3, one embodiment of the invention may allow the GCI program to design or create retail store interiors 300 offering the same graphic and functional enhancements as where chosen and implemented for the mall. In one embodiment, the graphic objective of the mall, store interior 300, and the store interior components may be to allow the customer to view items from a perceived, yet non-existent distance, enabling an assortment of product input for a buyer to select from. This is commonly known as window-shopping in brick and mortar stores and may include the illustrated images typically associated with a consumer walking through an actual mall or store. In one embodiment of the invention, to further enhance the visual effect, virtual showcases, shelving, display racks, etc., can be used to provide visual product recognition and identification, without written definitions or descriptions covering a Web page destroying the illusion. For a closer view of displayed items, another embodiment of the invention may allow the buyer to access (activate) a display case, displayed product, or the like, with the activation resulting in an enhanced view of the original image, providing for a magnified inspection capable of identifying all items in the display case, details of the displayed product, etc. The same magnifying technique can be used to further describe additional mall items and/or parts.

In one embodiment, a text description may be provided when the magnified view is great enough that the product can clearly be identified. The text description may be for product specifications, purchasing information, product usage, like product advertisement, or other information. Another embodiment may allow item information to be viewed as popup text using rollover techniques known in the art. In addition to the popup text, an embodiment may allow the text and/or product image to be viewed in a separate window environment, and may offer enhanced visual information that can include various view angles. The separate window environment can be offset from the prominent viewing image and may be repositioned by the buyer. Once an item has been chosen, another embodiment of the invention can reconstruct the view, placing the product and/or text into an associated setting. An example of this would be to select an item of clothing, and a new view of the clothing in a dressing room is created by the GCI.

In another embodiment, a store interior 300 can depict the store merchandise as viewed from aisles such as at large department stores with product group identifying signs located overhead of the shelved items. By choosing a location desired, for example by double clicking on the overhead sign or area of shelving for specified items, that area of the store will become the new viewing point in a manner similar to the previous example of clicking on the storefront. Unlike the restricted sizing of storefronts, the store interiors 300 can be of any size required to maintain the needed product displays such as but not limited to shelving, cloths racks, hanging areas, and display case 225.

Each view, from virtually walking into the store 300 to finding a specific item, can be constructed in a manner as to guide a buyer to an item. An example of one embodiment for a buyer to be guided to an item consists of the buyer first viewing multiple storefronts. After reaching a decision as what store appeals most, the buyer may choose the view of the appealing stores entrance. A new view (similar to store 300) may be constructed. The buyer may see multiple aisles of products on shelves with overhanging signs of the product classifications. Upon choosing a particular sign, the buyer's view may change to the shelving associated with the sign. In alternative embodiments, the buyer may also be offered doorways or entrances similar to 310 that upon choosing create new views similar to 300, offering additional services, illustrations, functions, products, or other features. Referring back to the previously mentioned shelving, items may be clearly visible for viewing or may require additional view selections as would be true of actual brick and mortar shopping.

In an alternative embodiment, additional graphical and functional enhancements can be provided for a store interior 300. These graphical and functional enhancements can be defined by the seller or the market system administration, and may be derived from buyer requests or recorded shopping habits. The before mentioned embodiments and functionality, as well as new embodiments and functions relative to a store 300 may be further described in the forthcoming detailed descriptions.

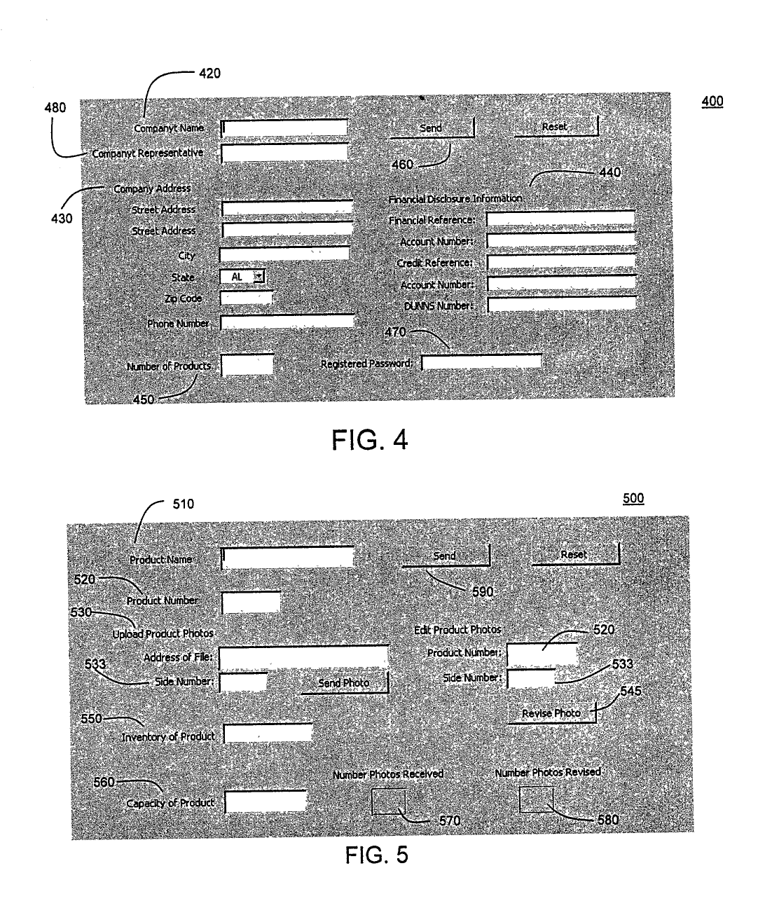

Returning to the interface process mentioned in the detailed description of FIG. 1, potential sellers 16 that access the seller's node 14 may be presented with a registration page 400. FIG. 4 illustrates a registration page 400 that may request various information relating to the seller including for example, the name of the seller 420, the address of seller 430, financial and credit information 440, and other information as is needed to allow for the transfer of money between seller and the mall. The seller may then select how many items it desires to display 450 in the one or more malls (such as multiple mall types). When the information has been completed, the registration request can be transmitted to the market systems database for processing. In one embodiment, this may be done by double clicking the cursor over the send feature 460. Alternative embodiments may require different or additional information for example, a company representative's name 480 or a password for pre-registered sellers 470. For one embodiment of the invention, once the information has been submitted and registration has been confirmed, the seller can advance to the next screen image. For another embodiment of the invention, the next screen image is illustrated as FIG. 5.

Referring to FIG. 5, the seller may be presented with, or provided access to programs, functions, downloads, code, and/or script, both server and client based, to provide further functionality and interface with the CGI. For another embodiment of the invention, all users may have access to specified integration of the mall features in a manner similar to that described above. An example of an interface integrating the previously mentions functionality and interface may include a product page 500. Product page 500 can provide the market system database with the seller's graphic product information. The page 500 can provide an authorized seller the ability to install, maintain, and delete items they sell in a real time fashion, which aids in eliminating purchased items from being discontinued or back ordered. In an alternate embodiment, the product page 500 may include entry requests for products the seller desires to display at one or more of the mall motifs. In one embodiment of the invention, products can be identified for storage into or retrieval from the database by the products name 510 and product number 520. In another embodiment, the product number 520 may be the products SKU number. The information and images can be used by the GCI to place realistic renditions of the product on display. In one embodiment of the invention, the seller may be requested to upload 530 at least one digital image, and may be of the front, back, and each of the sides 533 of each product the seller desires to display at a mall. In another embodiment, the seller may be required to submit digital images 530 in rotation about the three fixed axes and in increments and number required to display the image as a bitmap graphic, vector graphic, or bitmap vector combination to be described later. The multiple views of the product may be used by a subroutine that rotates the product about the three axes to allow the product to be viewed from all sides. In another embodiment, the products previously provided by the seller can be accessed for editing 545 by submitting the product number 520, and the side number identifying the product image. Upon activation of the revise photo button 545, a photo editing session complete with editing tools may be provided. The seller's inventory 550 and manufacturing capacity 560 of each product may also be requested. The number or photos received 570 and photos revised 580 are listed but in one embodiment, no information is processed by the database until the user has completed all uploading and editing and ends the session by activating send 590.

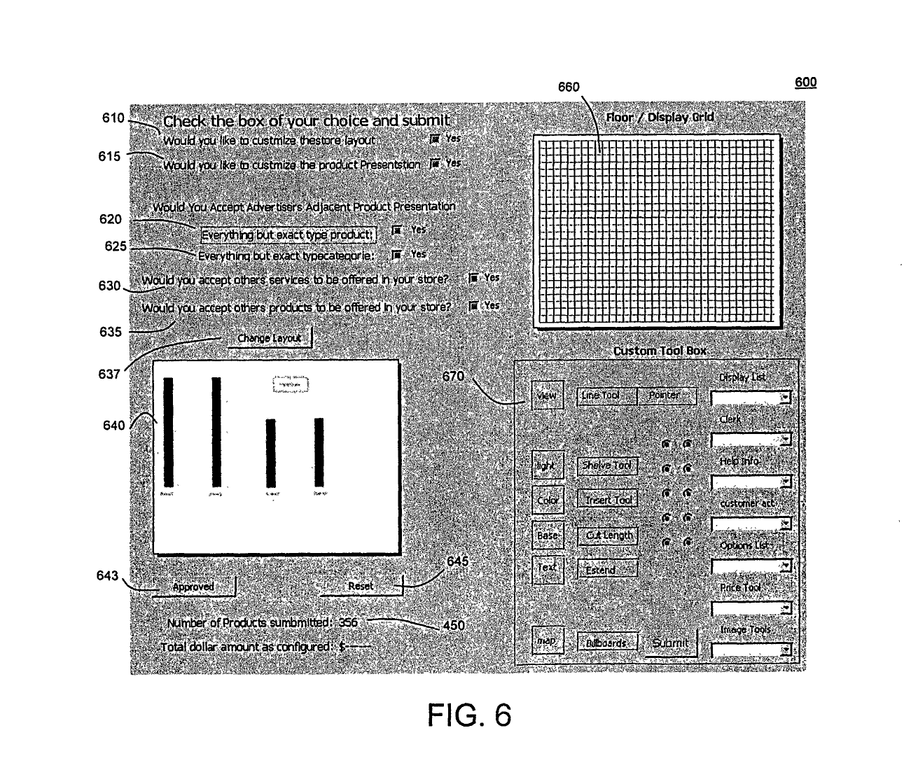

Referring to FIG. 6, the seller may be presented with, or provided access to a floor and product layout preference page 600 in a manner previously mentioned. The floor and product layout preference page 600 can prompt the seller to indicate whether it would like 610 to customize the display placement of a store interior, and/or presentation 615 of products within the store interior.

In one embodiment, if the seller indicates that it does not want to customize the presentation of products 615, the seller's products may be presented as designed by the market system administration. Alternatively, the products may be presented using a default presentation and product layout algorithm. The default presentation (display) and product layout algorithm may be based on various factors, including for example, price of product, inventory supply of product, product-type classification, product size constraints, etc., and may or may not reside in the CGI. One embodiment would require an array of the displays available within the mall along with each displays attributes, including but not limited to maximum and minimum requirements of product sizes suitable for being viewed in each display. A simple query may then assign the seller's products to a display when the products have characteristics that fall within the display array requirements. For example, when the GCI program queries the market systems database for product display information, a SQL code may list all product displays available and assign the product displays to a grid arbitrarily or by following preset restrictive parameters. Such restrictive parameters may be implemented by market system administration personnel or by sellers with authorization.

In another embodiment, the display and product layouts may be constructed using the above criteria or similar categorizing information without any human intervention. Still another embodiment that requires human intervention can provide a default display and product layout viewable in the viewing area 640. If the seller approves with the viewed product placement 643, the product may be given an attribute containing the placement information, the products may be placed in a database file of the associated display, or the product may be provided an alternative method of assignment.

In another embodiment, the seller may indicate that it does not want to customize display placement of a store. This condition may allow the seller to be presented with one or more default store display layouts in the viewing area 640. The default display layout may be provided by a default presentation and product layout algorithm. The default presentation and product layout algorithm may be based on various factors, including but not limited to shared product displays 635 and display size constraints. For example, the layout design for a seller that does not want to share a store interior with other sellers may be constructed based on price, product category, etc. For sellers electing to share a store interior with other sellers products or services 620,625, 630, 635, products can be laid out based on related products or services. In one embodiment, special consideration for accepting other sellers products or services, may be given that can include one or more, but not limited to specialty interior design, custom shelving, customer Internet connection location, and preferred mall placement of the storefront.

An alternative embodiment of the invention, default store display layouts may provide multiple pre-made store layouts with all attributes ready for placement in a mall with only the seller's product data to be entered into the database for the insertion of products on predefined displays. The seller can pick the store design that best fits its need based on such criteria as price, number of products, marketing strategies offered by market systems administration, etc. If the seller approves the layout as viewed, an approval 643 may be indicated. If the seller does not approve and optional display layouts are available, the seller may indicate disapproval 637 which may change the viewable store display layout 640 to an alternate description. The process of approval 643 and disapproval 637 is then performed again.

For one embodiment of the invention, when a display layout is approved by the seller the assigned store interior may be provided information for grid positioning of modular displays in accordance with the approved layout. In an alternative embodiment, the display layout and product presentation can be inserted in a location within one or more malls that can be chosen by a buyer, the seller, the buyer's internet connection location in relation to the seller, or market system administration.

If the seller indicates that it desires to customize the product display layout within a store interior, the seller may be presented with customization tools 670. In one embodiment, the customization tools 670 may be inactive until a customized application is required as is illustrated in FIG. 6. Additionally, the customization tools functionality may reside at the seller's node, may be downloaded to the seller through a communication device, and can be part of another functional program of the market system, in manners similar to those previously described. The customization tools 670 may include a simulated store and display case grid 660, and various customized features to select from, including for example colors, wall paper, shelving, facade, interior design amenities, billboard space, lighting, and the like. The displays, products, and associated information can be held in a database or the like, and can be assigned grid coordinates under a restrictive algorithm matching the sellers requested information as closely as is possible, while automatically preventing graphic inaccuracies. Alternatively, an employee of the market system administration may contact the seller and design the customized layout with the seller assisting. The market system administration contact, layout design, and seller assistance may be provided over the market system.

The functional programming required to provide the editing capabilities for a product layout as mentioned above, can be created using C++, Java, ASP or other programming language known in the art, and may be maintained on the market systems network. All executable programs, functions, queries, and any other software related material mentioned above as well as still to be mentioned can be constructed using one or more programming languages known in the art. The actual functionality and appearance of some interactive software may differ from that described, but operational content will remain consistent with that required to provide the market system full operability.

The seller may also be requested to indicate whether it would accept advertisements on billboard space within their store or assigned mall location, or adjacent a product display. For example, in one embodiment, a store display layout may include isles with products placed on display shelves along the isles. A buyer entering the store may enlarge a product image by pointing at or clicking on the product. Adjacent the enlarged view, a product description may be displayed along with extra space or billboard space for an advertisement (banner). In one embodiment, the billboard advertisement information may be entered and edited by authorized advertisers utilizing market system advertising software. One embodiment of the software may automatically check the entered advertising information for derogatory content and obvious product inaccuracies when compared with the associated advertiser and product information, which can be stored in a database. The seller may be further requested to indicate whether it would accept all market system approved advertising. In one embodiment, the market system approved advertising may include products and services that do not directly compete with a seller's products. The seller may be provided with a listing of product and service categories in which the seller may filter out selected advertisers or products. In one embodiment, these billboards can have the visual appearance within a mall setting of common posters, cathode ray tubes, neon signs, conventional signage, digital displays, etc. such as is illustrated in FIG. 2 as 276, and may alter their mall placement as a function of additional CGI parameters.

The seller may also be requested to indicate whether it would accept a different seller's product image to be presented in the same store as the seller's product. For example, a seller that sells a variety of golf balls can indicate that it would like to, or accept to present its golf balls in any store providing golf products, other than golf balls. Stores providing for example, golf clubs, golf tees, and the like would have an additional product to offer the buyer, thus enhancing the stores attraction to more buyers, as well as providing an additional sales avenue for the seller of golf balls. The cross marketing of related products in a store interior may be advantageous to both of the seller companies.

Once a store layout is in operation within a mall, the layout may be altered based on shopper buying patterns at the store. For example, in a golf store where a new golf club has the most user hits and/or sales, the store display layout, and/or the display case may be rearranged to prominently display the new golf club. The supporting or collateral products could be displayed in proximity to the new golf club in a manner to increase sales. When the new golf club is no longer the most sought after item in the store, the product layout can be readjusted to reflect this change. The product layout may also be altered to promote seasonal items. For example, in the sports store, ski related items may be prominently displayed during the winter season, while golf items may be prominently displayed in the spring and summer. In one embodiment, user data recorded to compare shopping habits of consumers is collected and retrieved from the market system database buy the seller to asses possible store display layout or product display changes. Another embodiment allows collected consumer data to be diagnosed by the market system administration or its affiliate to assess marketing strategies. These strategies may then be: offered as aids to sellers, may be used as a component of the default presentation and product layout algorithm providing updated default settings 640, may be used to alter the placement of storefronts within a mall, or may provide other alternatives to product placement and/or advertising.

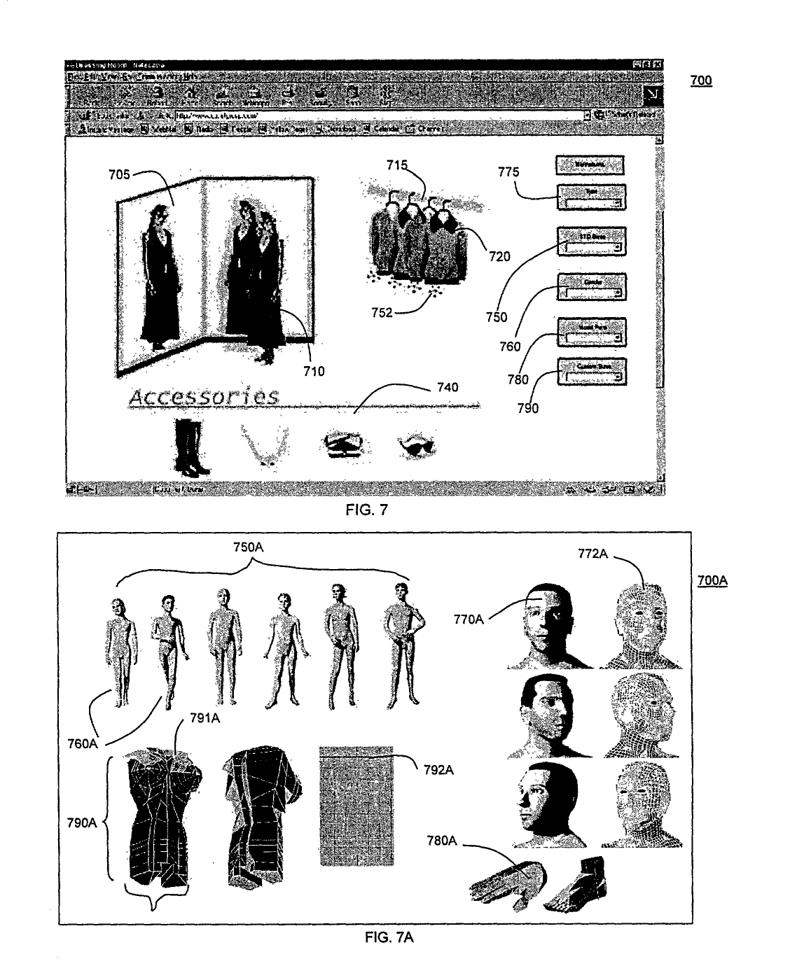

Referring to FIG. 7 and FIG. 7A, the details of an apparel viewing area, which can be one embodiment of a store interior, are illustrated 700. The apparel viewing area 700 can contain but is not limited to, a mirror 705, a mannequin 710, a cloths rack 715, cloths 720, and accessories 740. A viewing mannequin 710 is chosen by the buyer 12 to represent the buyer 12 trying on and viewing apparel. The mannequin may be picked from an assortment of standard mannequin models 750, shown for this embodiment as a pull down menu in FIG. 7 and as the assortment being offered in FIG. 7A. The standard mannequin models 750 represent mannequins of contour and size typically used in stores, with shapes and dimensions visually resembling professional human models. In an alternative embodiment, the mannequin may be modeled from consumer provided information 790 to represent the buyer. In one embodiment, the information provided by the buyer may be used to morph a flexible mannequin 790A into the measurements fitting the buyer specifications. An alternative embodiment may provide for the total construction of the mannequin 790A, made to fit the assigned values 790.

In one embodiment of the apparel viewing area 700, the created or selected mannequin 750 or 790, can be displayed as the viewing mannequin 710 facing a representation of a tri-fold mirror 705. The mirror representation 705 may use only two of the three views associated with a tri-fold mirror to eliminate confusing multiple views of mirrors on mirrors, but a full three-panel mirror and a single-panel mirror may alternatively be used with or without any multiple reflections.

Another embodiment provides the illusion of motion by accessing and activating the two-dimensional viewing mannequin 710 layers, as well as the layers of the mirrored image 705, and displaying the layered images in series. The displaying of the layers may be timed automatically such as in an animated gif file, or specific layers may be called upon dependent on movement of a pointing device or alternative consumer input. When the layers are viewed in series without interruption, the viewing mannequin 710 will appear to rotate from a vertical axis showing multiple mirrored views of the front, back, and sides of the viewing mannequin 710 rotating in an opposite rotation on the mirror panes 705. Alternative methods of rotation known in the art may be used in other embodiments. Additionally, true three-dimensional graphics may be incorporated to utilize all X, Y, and Z-axis information for integration within any part or embodiment of the invention.

In another embodiment, a mannequin type 775 is shown as a pull down list. The pull down list 775 allows for the selection of a viewing mannequin 710 from sizes available for the average consumer, also known as “off the rake” sizes. An example of the pull down size choices can be for a woman: 1p through 15p, 6 through 20, and 16+ through 24+. An example of sizes for a man can be small, medium, large, extra large, and extra extra large. These and other size choices used in this embodiment are typical and may be of varying formats or limits in alternative embodiments.

The model of mannequin may also be chosen as a “quick view” 755 (not shown) aid for viewing chosen fashions. The quick view mannequin 755 can be of a model, size, and gender pre-picked by the seller 16, or market system administration 18, and is to correspond with any selected attire 720. The quick view mannequin allows the attire to be quickly viewed, as it will look on an infant, boy, girl, man, or woman dependent on whom the clothing is intended to be worn. The quick view mannequin 755 can be a standard mannequin model 750, a type mannequin model 775, and can be preset gender specific 760 by the seller 16 dependent on the style of clothing 720. In one embodiment, the gender specific pull down list 760 can allow the buyer 12 to choose the gender 760A of a viewing mannequin 710 regardless of type 775.

In one embodiment, the accessories 740 are picked for placement in view of the buyer 12 by an algorithm querying all items fitting a set criterion. Examples of the criterion may consist of product aesthetics, manufacturer, selling store, selling price, etc. Additional methods for picking and placing accessories may be used.

In another embodiment, the quick view mannequin 755 can be assigned as an attribute to a specific item of clothing 720. The attribute can be used but is not limited to providing the buyer an option to “quick view” the article of clothing assigned the attribute on a human resemblance. In one embodiment, the quick view is accessible by the right click of a mouse. An alternative embodiment allows for each item of clothing to be viewed with a quick view mannequin by just selecting the item of clothing 720 and moving it just off a rack 715. Another embodiment has an icon 752 on or near an article of clothing 720 and when the icon 752 is activated, the quick view mannequin appears in the assigned clothes 755. In one embodiment, the quick view mannequin 755 may be positioned before a mirror as the viewing mannequin 710. Alternatively, the quick view mannequin 755 may be located arbitrarily dependent on the buyer preference, graphic restrictions, and/or other criteria not mentioned here.

The viewing mannequin 710 may be constructed as a two-dimensional or flat image using bitmap graphics, vector graphics, or alternative graphic standards known in the art. An alternative embodiment may construct the mannequin 710 as a three-dimensional image 770A using wire-mesh vector graphics 772A, polygon graphics, or similar techniques known to the art.

In another embodiment, all standard mannequins 750A are pre-created and stored in a database. In an additional embodiment, a copy of the mannequin file or its attribute signature can be transferred, after selection by the buyer, to the buyer as an applet or cookie, thereby eliminating the need for the buyer to go through the process of picking a mannequin on subsequent visits. Additionally, alternative methods of transfer and storage can be used.

In another embodiment, a partial mannequin 780 can be constructed as complete body images, or as body images in varying stages of completeness to fit the purpose of the buyer. Examples of a partial mannequin can include a torso to view a sweater, hands for viewing gloves 780A and feet for socks and shoes, or any combination of mannequin parts as may be needed. In an alternative embodiment, the partial mannequin 780 may be chosen from the custom size information 790 provided by the buyer.

In an additional embodiment, custom mannequins 790 can be created using programs hosted by the market system and then the custom mannequin 790 may be transferred to the buyer after creation, or may stored in a database. In an alternative embodiment, mannequin attributes can be stored as a bit stream with a trailer identifying the creating buyer. When the buyer, or a program responding to the buyer requests the attributes from either the buyers own storage or alternate storage location, a custom mannequin 790 is constructed as new for each session it is called. The custom mannequin 790 is then stored in temporary memory until the buying session is closed.

Additionally, a method of creating a wire-frame vector graphic hybrid may be used for creating any of the previously mentioned mannequins, as well as any products requiring a three-dimensional viewing. The wire-frame vector graphic hybrid is unique, and in this embodiment is constructed by assigning an attribute to each cell of a wire-frame model. The attribute can include at least one value from one of the following: a whole number value, a cell identifier, color information, and texture information. Alternative embodiments may use different values or parameters.

A two-dimensional flat surface model is next created of the item used above, or an item associated with it, depicting the surface texture and detail of the item as it appears in reality. For this embodiment, a wire-frame is created of a mannequin 790A with attributes assigned to each cell of the wire-frame 790A. A two-dimensional graphic can be created of the mannequin 792A, and of items associated with the mannequin like clothing 720 and accessories 740, as they appear in reality. The wire-frame mannequin 790A and two-dimensional graphics 792A may have an association where the clothing is chosen and viewed by size and gender, therefore the wire-frame mannequin must be of the same size and gender. The two-dimensional graphic 792A is then divided into cells of the same count as would be defined by the wire-frame cells as viewed perpendicular to the line of sight. Each cell of the two-dimensional graphic 792A is assigned an identifier and the two-dimensional cell identifier is passed to the wire-mesh cell associated with the perpendicular view. In order to accommodate multiple viewing angles of the wire-frame mannequin 790A, multiple two-dimensional images of the mannequin, clothing, and accessories can be created in the manner above. Using the amount of rotation required for each new view from the wire-frame mannequin 790A, the associated two-dimensional graphics 792A may be rotated by the same axis and distance. The new views may again be divided into cells and attributes. The result may produce a three-dimensional wire-mesh item that can be viewed from a perpendicular angle and appear as it would in reality using two-dimensional graphics assigned to each cell.

The cell attributes can be given a rotation variable, and as each cell of the wire-frame rotates, the rotation variable changes recursively as a function of the rotation angle. The rotation variable can be used by an algorithm associated with the two-dimensional graphics cells. The algorithm may alter the clarity of the two-dimensional cell dependent on the rotation variable. In one embodiment, clarity is the opacity, brightness, and contrast of a cell. At an angle of about 15 degrees off perpendicular, the two-dimensional cell becomes gray until it reaches a value that can lose all color, which is what would happen when the cells are behind the viewable front of the garment. When the rotation has reached a critical value, the two-dimensional cell again becomes gray and comes into clarity at an angle of about 15 degrees off perpendicular from the opposite side as above.

This technique will work for any solid object and for multiple axes'. The only values that need be stored from one session to the other are the cell attributes and the wire-frame model file. These can be kept on the market system database, or passed to the buyer as a cookie or applet.

A program that translates the vector graphic image into a viewable bitmap image may be used to view the wire mesh mannequin 710 in the window area; this is also known in the art as a vector graphic driver. Alternative embodiments utilizing various construction techniques may or may not require an additional viewing window.

The programs used to create the custom mannequins may be written in various codes such as C/C++, Java script, PASCAL, Pearl, or alternative languages known in the art. Alternative embodiments for the creation or storage of the viewing mannequin 710 may also be used while maintaining the functionality as described.

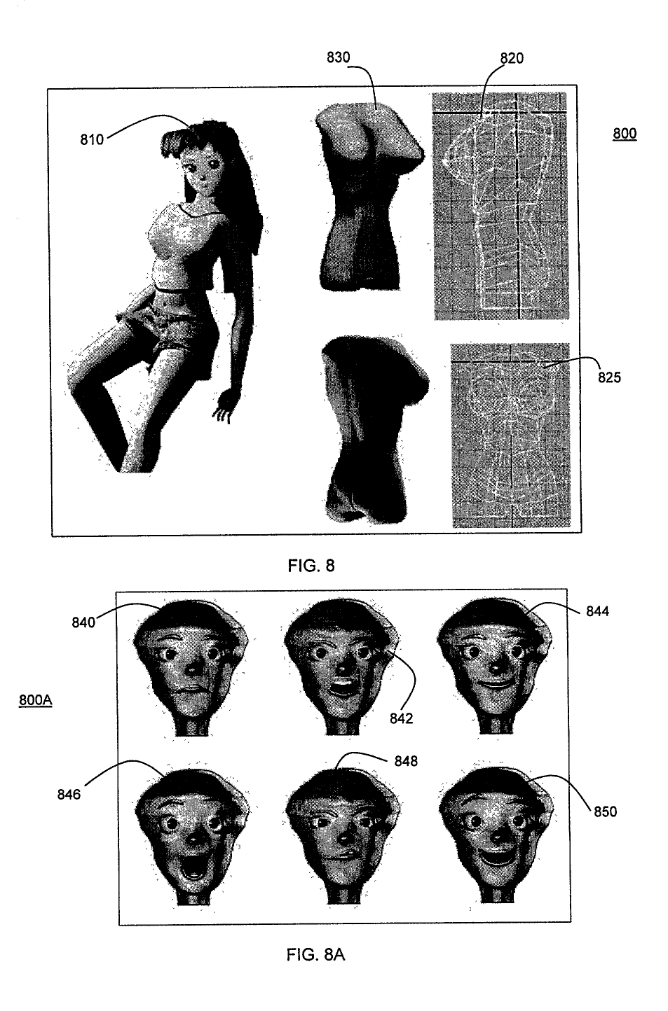

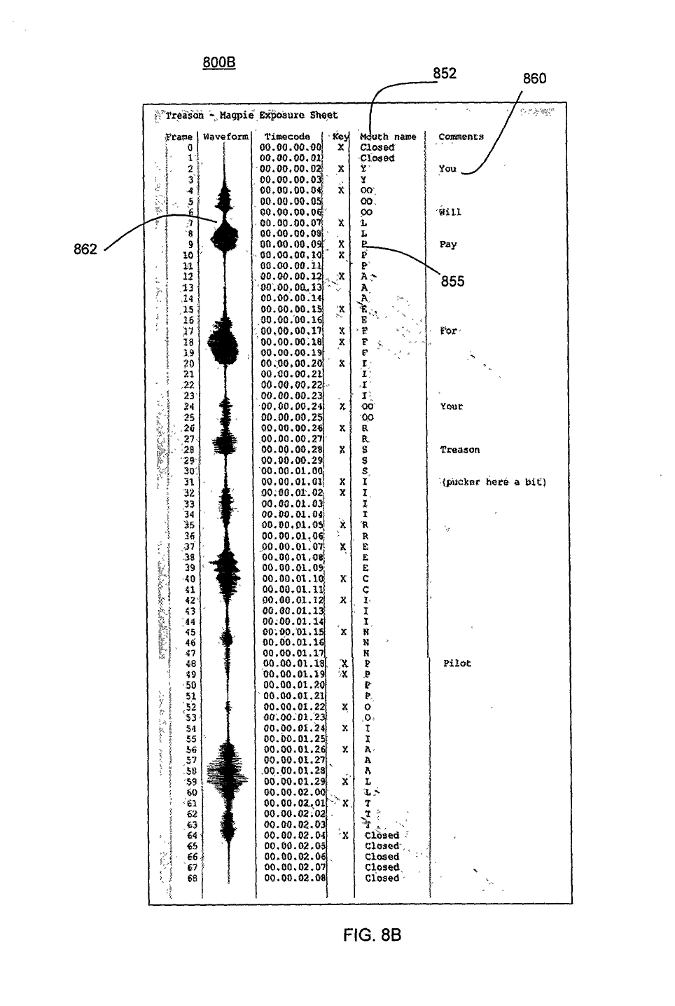

Referring to FIG. 8, custom mall shopping characters are defined 800. In one embodiment of the market system, the buyer may activate a functional page in a mall. The page can be named “character creator”, and may offer a tool kit and prefabricated questions pertaining to attributes typical of describing a human being. The purpose of the questions is to aid the buyer in designing their own character to interact with the mall and its internal features. Illustrated in 800, a sample female character 810 is shown in a completed form. The character can be created in a fashion described for creating the custom mannequins of FIG. 7, but is given much more functionality and creative leeway. For one embodiment, the character may be two-dimensional in construction and operation, but an alternative embodiment may have a three-dimensional character in construction and operation. An obvious alternative embodiment can have a combination of both dimensional attributes. The character construction 800 shown in FIG. 8 is a three-dimensional character in different stages of completion. In one embodiment, the character creator will request information from the buyer pertaining to the torso dimensions of both side 820 and front 825 views. If the buyer is unfamiliar with human characteristics defined as dimensions, an alternative embodiment may provide one or more prefabricated characters for the buyer to choose. Additionally, the characters may be made of pre-constructed body parts, picked from a list by the buyer and assembled, forming a completed character. For the custom torso information 820/825, an internal algorithm of the market system can provide a wire-mesh torso as a function of the supplied dimensions, and in an additional embodiment, cover the wire-mesh torso with a textured skin of a color picked by the buyer. With the torso complete, a buyer can be solicited for dimensional information of feet, hands, arms, legs, and head. An alternative embodiment can offer any body part to be chosen from a list of completed parts, and constructed with the already completed parts in a fashion previously described for creating a custom mannequin. Additional information on the creation of three-dimensional characters can be found in articles by Michael Comet at http://www.commet-cartoons.com/toons/3ddocs/.

With the character 810 complete, another embodiment can offer the buyer a choice of national or ethnic clothing. The clothing may be chosen from a list of completed wire-mesh clothes designs and like the mannequin clothing, may be given a color chosen from several colors and applied to the graphic as an onion skin, as is known in the art. The finished character 810 may be implemented with additional functionality. In one embodiment, the character 810 is created capable of walking, squatting, sitting, standing, running, grabbing, pulling, and many other basic mobility functions.

An alternative embodiment may introduce facial functionality to the character 810. FIG. 8A illustrates expressions common to human interactions, and include but are not limited to sorrow 840, anger 842, joy 844, fear 846, disgust 848, and surprise 850. In a like fashion to the expressions 800A of the character 810, a phonetic alphabet and words can be incorporated into a characters vocabulary. In FIG. 8B, a printed waveform 862 named “Treason” 800B is illustrated documenting a character mouth setting 852 along with the associated alphabetic letter 855, and complete word 860. Using Treason 800B and like waveform documents, a vocabulary for each character created in the market system may be provided as attributes to the facial structure wire-frame. By providing the mouthing of a letter or word and associating the letter or word with a real analog audio wave, one embodiment of the invention can allow buyers to speak over the communication node and be heard within a mall, and their character representation 810 will mouth the buyers words in a near real time. By implementing a short time delay, the wording and Phoneme can match. Alternative methods for wording and Phoneme (speech) may be used including but not limited to time synchronization, digital pulse, and other techniques known in the art and may include secured networking such as VPN or keyed communication to restrict the access or use of speech.

In one embodiment, utilizing the character functionality of the customized mall shopping character 810, the connectivity described in FIG. 1, and various input devices used in virtual reality applications like the gloves described in FIG. 2A, the buyer can move freely through the mall, talking and hearing other individuals as they are imitated by each owns character 810. Facial features 800A may be implemented with an algorithm that estimates the voice stress and intensity in order to provide the buyer's character 810 with proper expression commands. In another embodiment, the buyer using all necessary IVR input and output equipment, can see inside the mall similar to how the character they control would see, and may be able to interact with products and services by using the VR gloves to for example, manipulate the products on a shelf.

Another embodiment can provide for a companion buyer or buyers to accompany a buyer as a group of interactive characters 810 shopping and browsing through a mall. An attribute of the one or more companion buyers can be placed as identifiers in a database specifying the lead buyer as having maneuvering control throughout the mall for the entire group. In one embodiment, the attached companion buyers can exit the group by entering a keystroke or similar entry method. In another embodiment, the group can hear only themselves speaking while in the group by utilizing a piped connection between each of the group members and the CGI allowing each to overhear themselves as a group by combining their inputs to a single output source, with one embodiment adding a low background noise to represent background sounds. Secure network connection techniques similar to this may be used in additional embodiments throughout the invention. In one embodiment, an identifier may be received from a buyer or seller that is unique. A unique identifier may include for example, the license number of an operating system or program, as read from the registry or similar listing. The identifier may be used by the CGI as an encryption key to provide the buyer, seller with secured access. The key may be then used to provide additional group members with the same information.

In another embodiment, the characters within a mall setting can be limited to a set number in order to prevent the mall from becoming over crowded and unpleasant. In one embodiment, this number may be, and will consist of any buyer entering in a FIFO system. A database may contain the information of who and how many are in a mall at any given time, and may govern the entrance of buyer specified friends to allow for shopping companions. An alternative embodiment will assign attribute specifications of buyers and their companions to be read by the market system from a buyers data-recording device, to be used in governing the number of buyers allowed to be viewed in any one mall. In one embodiment, the database, keeps record of all visitors to a mall. The database can govern the virtual number of buyers in a mall by providing a common stream socket for a set number of buyers to the first buyers to access the database as new session mall customers until the set number is reached. At that point, the database can proceed to the next group of buyers and offer a new common stream socket address. Alternate methods of multiple connectivity and population governing may be used in alternate embodiments.

Another embodiment provides a storefront and store interior for a live chat room. Visitors may enter and hear, see, talk, and likewise interact with the character representations congregated there. One embodiment would assign a governing entity, for example the market system administration, to police the language, actions, and number of participants, etc. to assure a secure chat room. Individuals violating rules may have a virtual cop escort their character to the door and the buyer in control may be issued a penalty. In another embodiment, individuals may be assigned control over their socket connection, database id, or similar means to offer control of their privacy in case of unwanted conversation.

Another embodiment provides a storefront and store interior for a movie theater. Operating in the same manner as the before mentioned chat room, the movie theater may offer current run trailers and advertisements to the occupants. In one embodiment, the chat traffic can be switched by a buyer to a lesser number of actively speaking buyers. Alternatively, the chat traffic can be volume controlled by the buyer. Like all before mentioned aspects of a mall, the theater can be depicted and illustrated as an actual theater that may include but is not limited to seats, ushers, ornate graphic and/or mosaic wall decor, large viewing screen, etc.

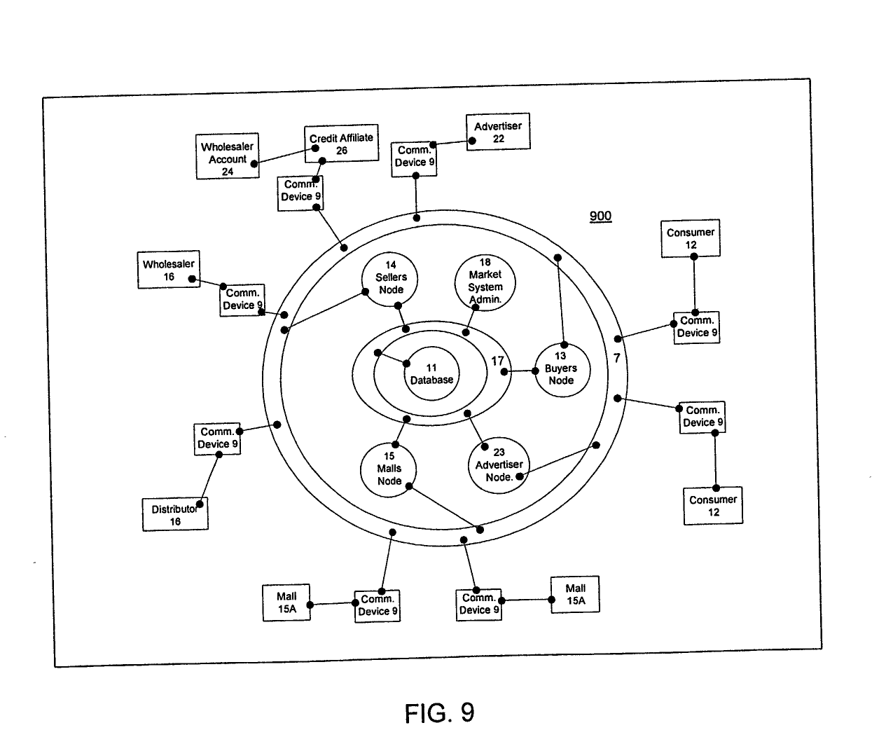

Referring to FIG. 9, another embodiment of a market system is generally shown at numeral 900. Market system 900 may include communication nodes and connectivity hardware, software, and network protocol as the market system. The noted differences are however; a wholesaler can now be in communication with a distributor in a like manner described in FIG. 1. In another embodiment and in a like manner described in FIG. 1, a wholesaler 16 is in communication with its wholesale financial account 24, which is in communication with a credit card affiliate 26. In another embodiment and in a like manner described in FIG. 1, an advertiser 22 may communicate through a communication device with an advertising node 23 via a network connection. The advertiser node 23 can be in communication with a database 11 and the buyers node, sellers node, and malls node as shown.

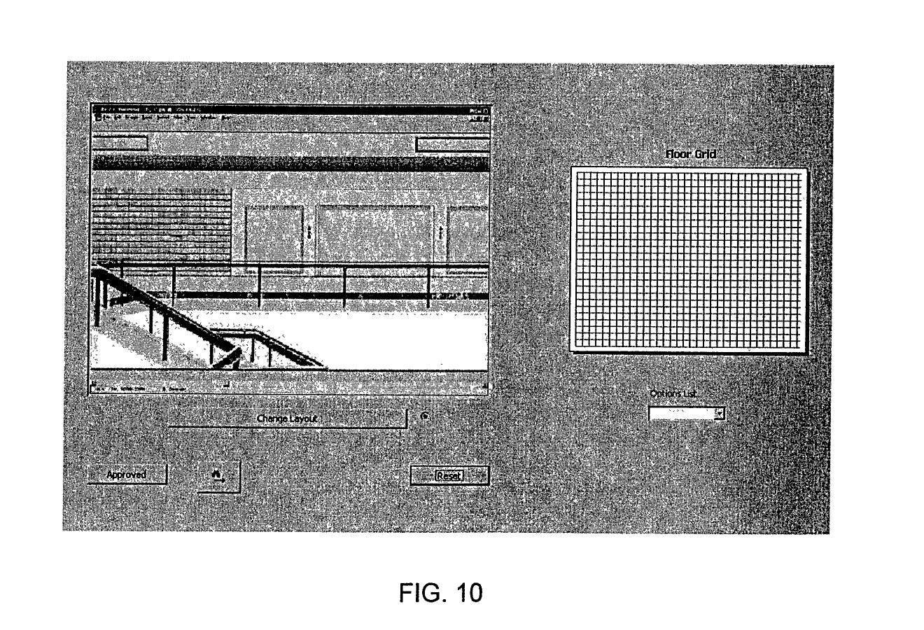

Referring to FIG. 10, once a store layout is accepted by the seller, the seller may be presented with the location of its store within a mall that was selected by the seller. The seller may indicate whether it accepts or rejects the assigned position of the store within the mall. The seller may also be presented with a mall layout showing alternative store placement. The seller may then select an alternative placement if it is available.

The seller may repeat the product layout of the store and positioning approval steps for each mall selected by the seller. Alternatively, the seller may use the same product layout for its store in each mall.

In one embodiment, the sellers input data for registration and product selection can be indexed in a seller database. The seller database may be in communication with the seller's node. Each product description along with their respective product images can be uploaded from sellers in communication with the sellers node and stored in the sellers database.

The product data, which may include the uploaded product images, respective manufacturer, product description, advertiser preferences, store-sharing preference, etc., can be received at the seller's node. Each product may be assigned a product class indicator, which can also be stored in the sellers database.

The seller may indicate whether it will accept placement of other seller's product in the same store. A determination is made whether the seller has indicated a willingness to have others sellers products in the same store. If the product has an associated seller that has indicated its willingness to share store space with products of different manufacturers, a search of the indexed product database may be run to determine compatible products, which may be displayed in the same store within a mall. As it is contemplated, that product input will be continuously entering the sellers database, each time a search is run new product may be available, and the product layout for the stores may be optimized.

For example, a first seller enters his golf balls as product in the system. The system searches the sellers database, but finds no compatible product. A second seller then uploads his product, golf clubs, and the system again searches the sellers database. This time, the search results return the product having a like assigned product category number, which in this case is the golf balls. The golf clubs may then be presented in the same store as the golf balls. If later the seller of golf balls also uploads a line of clubs, which compete with the second seller's clubs, the system will recognize this and query the first seller as to whether he will still accept second seller's clubs in his store.

Once the search is completed, a layout of the products of the various manufacturers may be sent to the manufactures for approval.

As discussed above, in one embodiment the product image data may include a front, back and each side of a product. These two dimensional images may then be applied as wallpaper to a cube or other three-dimensional shell. This will allow the appearance of a three dimensional product to the shopper. In an alternative embodiment, an actual three-dimensional image of the product may be used.

The advertiser's node can allow potential advertisers to register and bid on the placement of advertisements or other e-commerce services or solutions in various locations in the stores and mall. The advertiser's node can also provide the advertiser with historical and/or real time data relating to product sold through the market system.

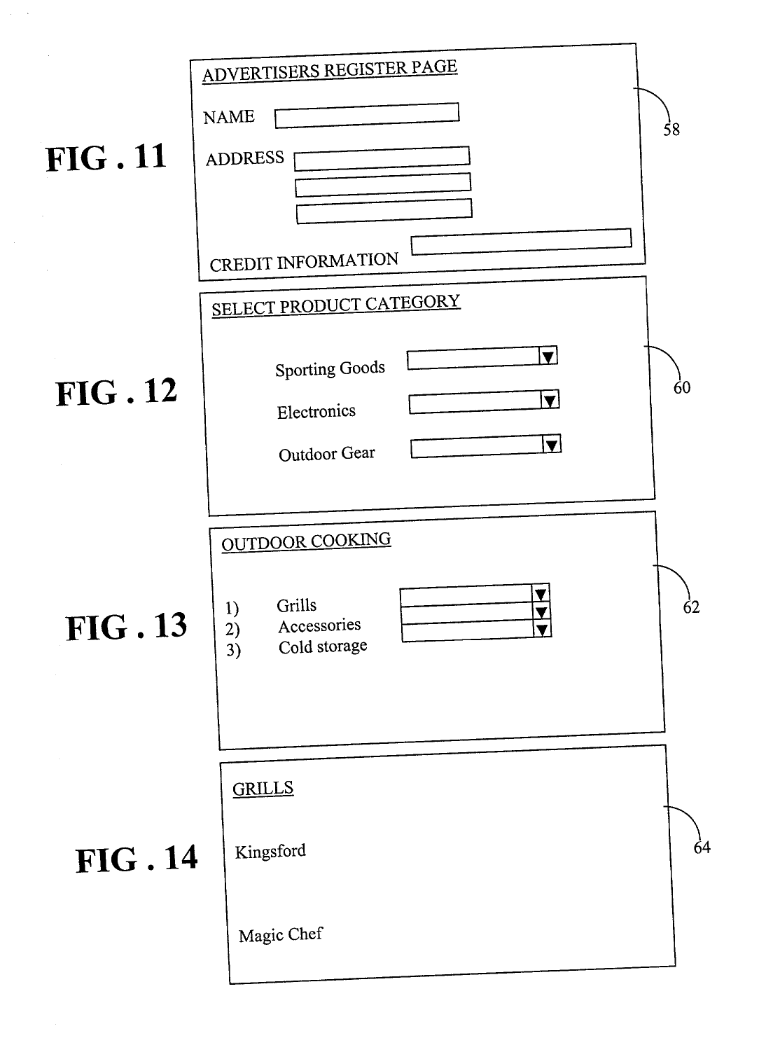

Referring to FIG. 11, upon accessing the advertiser's node, the potential advertiser may be presented with an advertiser's registration page, which may request various registration information, including, for example, name, address and other credit information (58). The registered advertiser may then be approved or disapproved based on criteria established by the market system, for example, credit/financial information. Once a potential advertiser has been approved by the market system, the advertiser may access various product and product category specific information formatted to provide useful tools to the advertiser.

Referring to FIG. 12, for example the advertiser may request a specific product category (60). In one embodiment, the product categories may be the same as the product classification categories which can be assigned to each product as a number upon upload into the seller's database, as discussed above.

Referring to FIG. 13, once a particular product category is selected, a listing of subclasses within the product category may be listed (62). The subclasses may also be the same as the product classification subclass assigned as a number to the product.

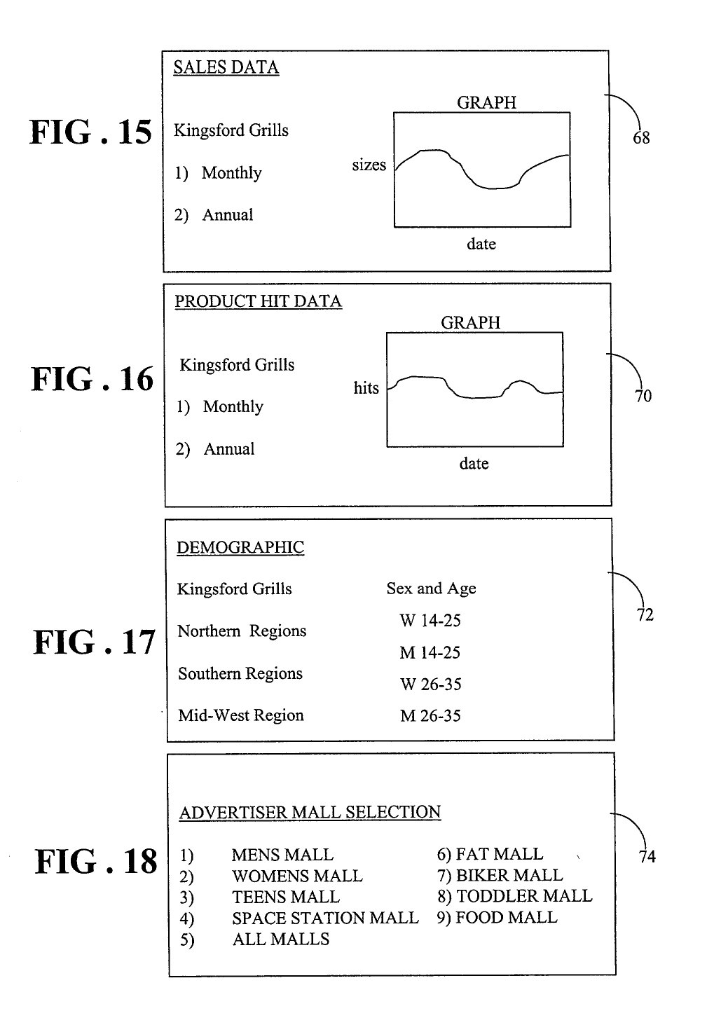

Referring to FIG. 14, upon selecting a subcategory, in one embodiment, a listing of manufacturer's may be displayed (64). The advertiser may select to advertise at any level, that is, at the product category, the sub category, or specific manufacturers. Referring to FIG. 15, sales data of a specific product category, subcategory or specific manufacturer, as shown, may be displayed (68). In addition and/or alternatively, as shown in FIG. 16, product hit data may be provided by product category, sub-category, or specific manufacturer. A product hit can be any click or access of a specific product. A product hit may also be counted only when the specific product is accessed or viewed for a predetermined period. The sales data and product hit data may be displayed in tabular, graph or other form to allow advertisers to gain insight into sales and shopping pattern of customers during different periods of the year. In addition, as shown in FIG. 17, demographic data relating to purchasers and purchasers accessing a product for a predetermined period may be provided to the advertisers to provide further understanding of shoppers and shopping patterns.

Referring to FIG. 18, advertisers may select from one or more malls in which they desire to place an advertisement or offer an e-commerce opportunity, including a product service, or other opportunity.

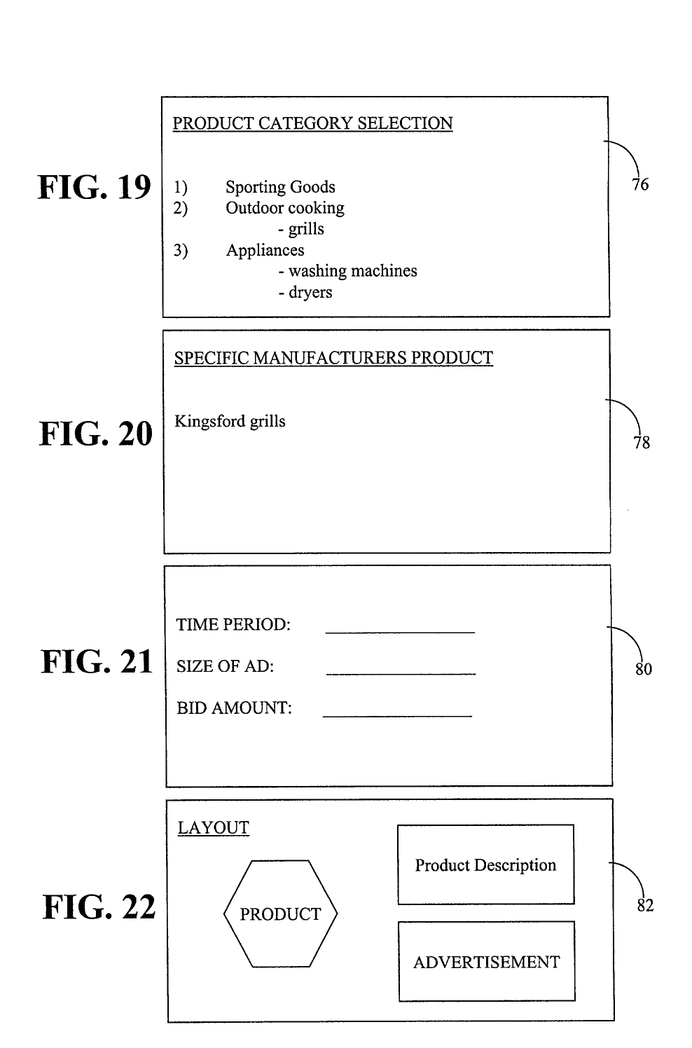

Referring to FIG. 19, advertisers may select a product category 76 or subcategory. In addition, as shown in FIG. 20, the advertiser may select a specific seller's product 78.

Referring to FIG. 21, once the advertiser has selected at which level it desires to advertise, it may be presented with or access an advertisement bid page 80. The advertisement bid page requests entry of various information, to allow the advertiser to place an ad in a mall, store, solicitor, or product of its choice. The requested information may include a period for the ad to run, the size of the ad, a bid amount for the ad. Once this input is received, an advertisement layout page 82 may display the ad in the chosen format, as shown in FIG. 22.

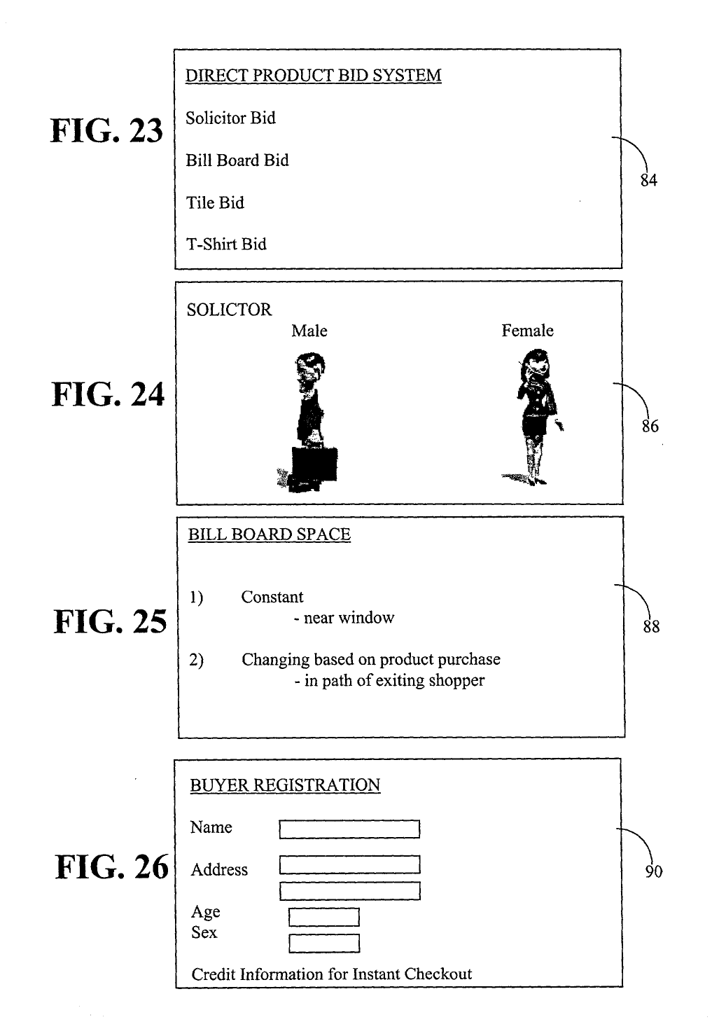

Referring to FIG. 23, advertisers may place bids 84 to advertise using solicitors, billboards, floor tiles, T-shirts or tattoos on other shoppers or solicitors, or the like. Bids may be placed on the fixed spaced ads on billboard space, tiles or the like in a selected mall or store within the mall. Bids may be for a specific period of time.

Referring to FIG. 24 if the advertiser desires to place an ad on or with a solicitor, a selection page 86 may be presented to allow the advertiser to select the sex, age, body type, accent, hair color, complexion, race, or other features that may have an influence on target shoppers. For example, in a mall specializing in selling hunting equipment, which may have predominantly male shoppers, an advertiser may select to use an attractive female solicitor.

Referring to FIG. 25, an advertiser may select space 88 where the ad remains constant or where the ad changes based on what is purchased by a shopper. For example, an advertiser may select fixed ad space around the perimeter of an eye-catching window, for example, a view from the space station. The advertiser who may have multiple products to advertise may select, for example, billboard space, a tile or the like in the pathway of shoppers exiting a store, or other noticeable location. The ad may then be changed based on product purchases, seasonal or holiday periods, sex of shopper, age of shopper, or other preferences of selected shopper or shoppers. For example, an advertiser of shoe polishes may purchase a tile space near the exit of a shoe store. The shoe polish advertiser may then upload a variety of ads for its different shoe polish products. The ads may be targeted to age groups, sex, or other shopper preferences, which coincide with the preference the buyers may enter when first registering on the buyers site. When middle-aged female shopper from the Midwest purchases a pair of black shoes, this information is compared with the uploaded ads and the advertisers preferred ad for black shoe polish is displayed in the advertiser's purchased tile space.

Referring to FIG. 26 a buyer accessing the buyer's node may be asked to register and provide information 90 including, for example, name, address, age, sex, credit information, and other profile information.

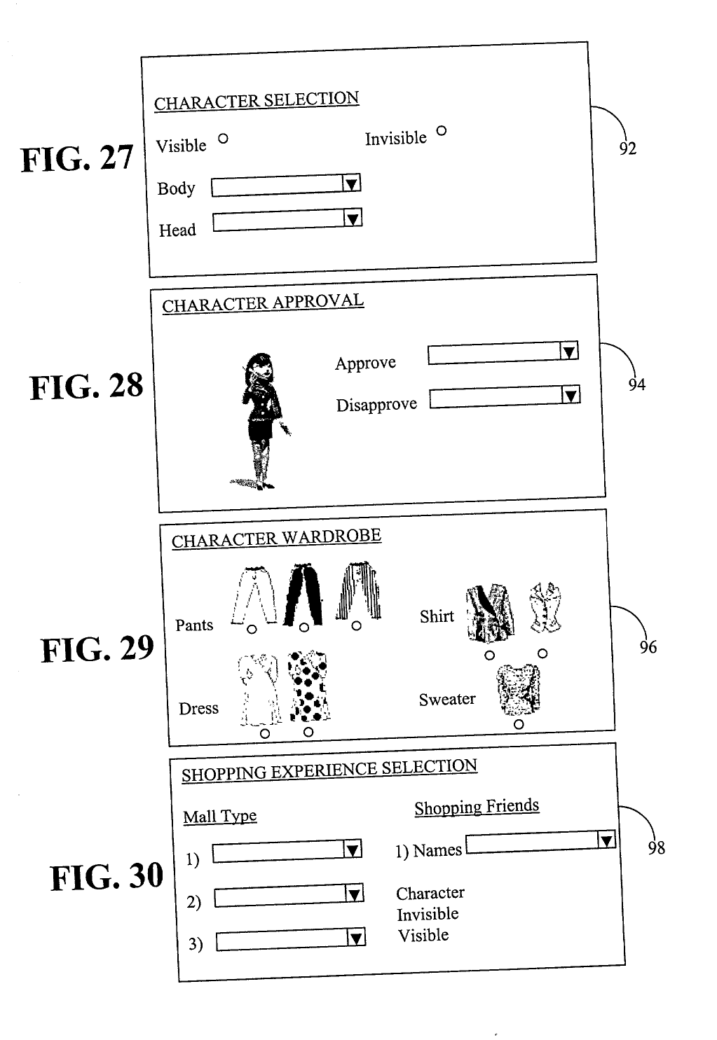

Referring to FIG. 27, in one embodiment the registered buyer may select how he/she is viewed by other shopper's in the mall 92. For example, the buyer may choose to be visible or invisible to other shoppers. The buyer may select from various graphic figures. In one embodiment the buyer may upload a picture of his head and/or his body for construction of a three dimensional character. The body and head may be matched with other available heads or bodies. Once constructed, FIG. 28 provides the buyer with an interface that can be used for approval of his character 94. The buyer may also be able to clothe his character with a selection of provided clothing images 96 as illustrated in FIG. 29. Alternatively, the clothes worn in a picture uploaded by the buyer may be used.

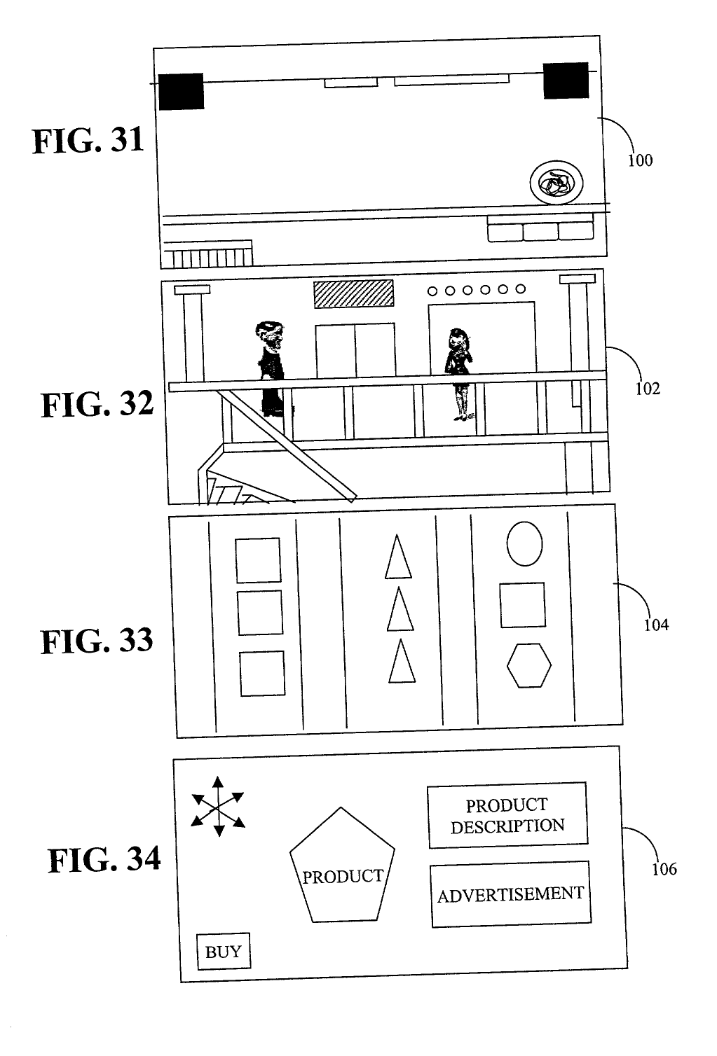

Referring to FIG. 30, the buyer may select from a choice of shopping experiences 98 that may contain variables such as lists of different theme malls and types. The buyer may also indicate names of other shoppers he wishes to shop with in his selected mall. The buyer may be given instructions or a help bar that will allow him to be visible or invisible to the other shoppers. The buyer can also select between at least a third person top view 100 of himself in the mall as illustrated in FIG. 31, and a first person elevation view 102 as illustrated in FIG. 32. Referring to FIG. 33, inside a store within the mall, the buyer may use the elevation view to see a complete selection of products within the store 104.

Referring to FIG. 34, a buyer may select any product on the store shelves to view an enlarged three-dimensional representation of the product 106. In one embodiment, when a product is selected, a product description and at least one ad may appear alongside the enlarged view of the product. The product may be rotated to view all sides. A buy button may appear on the same screen to allow quick purchase.

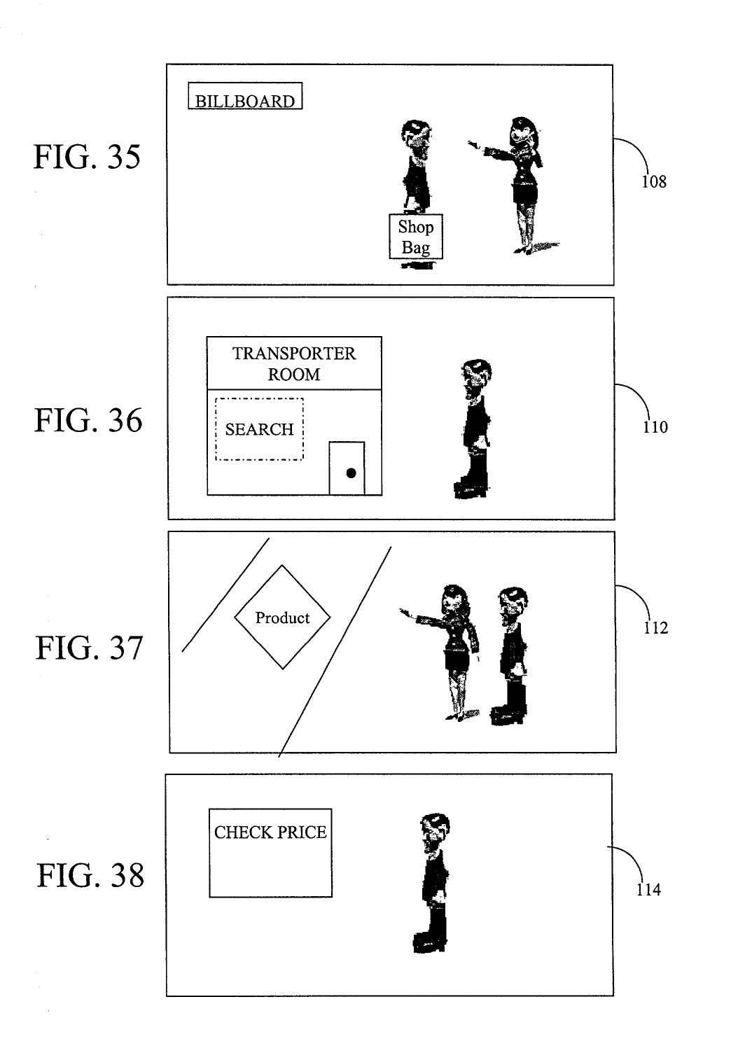

Referring to FIG. 35, in one embodiment, once the buyer purchases an item, advertising space and solicitors in the mall may change to specifically target the customer 108. The ads may be displayed on billboard space within the store and mall, floor tiles, on clothing of other shoppers and solicitors and on shopping bags. A solicitor may also be activated to solicit the shopper based on his purchase. The character chosen for the solicitor may be based on the buyer's profile. For example, a single male buyer may be solicited by an attractive female solicitor. In one embodiment, the accent of the solicitors voice may be changed to reflect different regions of the state or country.

Referring to FIG. 36, a buyer who has a good idea of the product he wants may step on a pedway 110 that delivers the buyer to the desired types of product. Alternatively, the pedway (motorized walkway) may deliver the buyer, or the buyer may be directed by signs, solicitors, store, clerks, or the like to a transporter room, where the buyer can conduct a product search and be transported to the store having the product that he wants, or to a dynamically created store with all products matching the product category desired by the buyer.

Referring to FIG. 37, in one embodiment, where the shopper meets up with a friend, the at least two shoppers can view products together 112. That is one shopper may take control of another shoppers view, so that when the lead shopper selects a product, the linked friend can view the product as it is rotated by the lead buyer. The friends may also be able to communicate by typing in text and/or having a live Internet voice link.

Referring to FIG. 38, the buyer may have access within a store to a check price feature 114. The buyer may be able to check the price of the stores product to the same product at other on-line retailers. There may be a feature to match the price of the lowest offering. The search feature may also be running continuously in the background to assure that the mall is offering the lowest price for the manufacturer's products. The price of the product offered at the mall may continuously adjusted to be at least as low as the lowest alternative retailer's price. Alternatively, prior to automatically adjusting the product price at the mall, the manufacturer can be notified that a lower offering price is available at another retail site. The manufacturer may then approve or disapprove a lowered price for the mall. The manufacturer may also have the option to approve automatic reductions for specific products. In addition, the manufacturers may have the option to lower prices to aid in clearing its inventories of discontinued product, by providing a built in profit for such clearance reductions to the mall operator.

In situations where a buyer places an order to purchase, but the manufacturers own inventories are low, the buyer may be presented with an option of receiving a discount if he waits a period of time for shipment. Alternatively, the buyer who needs the product immediately may be directed to another retailers site with the lowest price.

In a space station mall, for example, live or recorded pictures of the earth, moon, planets, and stars taken from a space station (i.e. Space Station) may be viewed live through a satellite feed to the mall and using, for example, streaming video through a window or windows in the mall. In an African Savannah Mall, for example, live or recorded video of the African Savanna may be displayed through one or more windows in the mall or in stores within the mall. In an Underwater Mall for example, live or recorded video of a coral reef may be displayed through one or more windows, walls, floor or ceiling of the mall.

In one embodiment, advertisers or sellers may be given the opportunity to advertiser billboard space adjacent the window space in a store. This may be used as an attraction to the store or advertiser. In an African Mall, for example, live or recorded video of the African Savanna may be displayed through one or more windows in the mall or in stores within the mall. In an Underwater Mall, for example, live or recorded video of a coral reef may be displayed through one or more windows, floor or ceiling of the mall.

While specific embodiments of the present invention have been shown and described, it will be apparent to those skilled in the art that the disclosed invention may be modified in numerous ways and may assume many embodiments other than those specifically set out and described above. Accordingly, the scope of the invention is indicated in the appended claims, and all changes that come within the meaning and range of equivalents are to be embraced therein.

The present invention may be embodied in other specific forms without departing from its spirit or essential characteristics. The described embodiments are to be considered in all respects only as illustrative and not restrictive.

We claim:

1. A method of operation an on-line market system comprising:
receiving a photograph of each of a plurality of sides of a product from a seller;
constructing a three dimensional product image from the photographs; and
displaying the three dimensional product image in a three dimensional mall representation.

2. A method of operating an on-line market system comprising:
receiving at least one product image at a seller's node;
storing the product information in a seller's database;
constructing a three dimensional store,
positioning the product image in the store;
constructing a three dimensional mall;
positioning the store in the mall; and
providing buyer access to the mall from a buyer's node.

3. A method of operating an on-line market system comprising:
receiving buyer profile information from a buyer;
storing the buyer profile information in a buyer's database;
receiving ad selection input from an advertiser;
receiving a purchase input from the buyer; and
displaying an ad from the ad selection input in a three dimensional mall based on the buyer profile in response to the received purchase input.

4. A method of operating an on-line market system comprising:
receiving product data from a plurality of sellers;
storing the product data in a database;
receiving product category search criteria; and
constructing a store to include product data based on the product data matching the product category search criteria.

5. A method of operating an on-line market system comprising:
receiving user character selection input from a buyer;
constructing a three dimensional shopper based on the character selection input;
directing the three dimensional shopper through a three dimensional mall; and
interacting the shopper with three dimensional solicitors.

6. A method of operating an on-line market system comprising:
receiving buyer friend input from a buyer;
linking a three dimensional friend corresponding to the buyer friend input via a network connection with a three dimensional buyer in a three dimensional mall; and
sending an identical visual display to operators of both the three dimensional fiend and the three dimensional buyer via a network during the linkage.

7. A method of operating an on-line market system comprising:
opening a plurality of socket connections between a mall network and a buyer;
opening a plurality of socket connections between a mall network and a second buyer; and
providing a database means to route a network connection between the buyer and second buyer wherein the connection provides bisynchronous communication of speech and visual.

8. A method of operating an on-line market system comprising:
providing a network means for voice transmission;
providing a character means to mock the voice transmission;
providing a software means to process the voice transmission to the mocking character in near real time wherein out of synch lip movement is negligible.

9. A method of operating an on-line market system comprising:
receiving buyer purchase input;
comparing the buyer purchase input to a database of product categories with corresponding ads; and
transmitting an ad corresponding to the product category matching the purchase input to a billboard space in an on-line mall.

10. An on-line market system comprising:
means for receiving a photograph of each of a plurality of sides of a product from a seller;
means for constructing a three dimensional product image from the photographs; and
means for displaying the three dimensional product image in a three dimensional mall representation.

11. An on-line market system comprising:
means for receiving at least one product image at a seller's node;
means for storing the product information in a seller's database;
means for constructing a three dimensional store;
means for positioning the product image in the store;
means for constructing a three dimensional mall;
means for positioning the store in the mall; and
means for providing buyer access to the mall from a buyer's node.

12. An on-line market system comprising:
means for receiving buyer profile information from a buyer;
means for storing the buyer profile information in a buyer's database;
means for receiving ad selection input from an advertiser;
means for receiving a purchase input from the buyer; and
means for displaying an ad from the ad selection input in a three dimensional mall based on the buyer profile in response to the received purchase input.

13. An on-line market system comprising:
means for receiving product data from a plurality of sellers;
means for storing the product data in a database;
means for receiving product category search criteria; and
means for constructing a store to include product data based on the product data matching the product category search criteria.

14. An on-line market system comprising:
means for receiving user character selection input from a buyer;
means for constructing a three-dimensional shopper based on the character selection input;
means for directing the three dimensional shopper through a three-dimensional mall; and
means for interacting the shopper with three-dimensional solicitors.

15. An on-line market system comprising:
means for receiving buyer friend input from a buyer;
means for linking a three dimensional friend corresponding to the buyer friend input via a network connection with a three dimensional buyer in a three dimensional mall; and
means for sending an identical visual display to operators of both the three dimensional fiend and the three dimensional buyer via a network during the linkage.

16. An on-line market system comprising:
means for opening a plurality of socket connections between a mall network and a buyer;
means for opening a plurality of socket connections between a mall network and a second buyer; and
means for providing a database means to route a network connection between the buyer and second buyer wherein the connection provides bisynchronous communication of speech and visual.

17. An on-line market system comprising:
means for providing a network means for voice transmission;
means for providing a character means to mock the voice transmission; and
means for providing a software means to process the voice transmission to the mocking character in near real time wherein out of synch lip movement is negligible.

18. An on-line market system comprising:
means for receiving buyer purchase input;
means for comparing the buyer purchase input to a database of product categories with corresponding ads; and
means for transmitting an ad corresponding to the product category matching the purchase input to a billboard space in an on-line mall.
